(19) United States
(12) Patent Application Publication
(10) Pub. No.: US 2013/0236867 A1
(43) Pub. Date: Sep. 12, 2013

(54) BRAIN RE-TRAINING SYSTEM FOR AMBULATORY AND/OR FUNCTIONAL PERFORMANCE THERAPY

(71) Applicants: Arik Avni, Metar (IL); Ronit Friedman, Lehavim (IL); Dror Salah, Beer-Sheva (IL); Ayelet Faust Eshed, Hod Hasharon (IL)

(72) Inventors: Arik Avni, Metar (IL); Ronit Friedman, Lehavim (IL); Dror Salah, Beer-Sheva (IL); Ayelet Faust Eshed, Hod Hasharon (IL)

(73) Assignee: ANDANTE MEDICAL DEVICE INC., White Plains, NY (US)

(21) Appl. No.: 13/429,095

(22) Filed: Mar. 23, 2012

Related U.S. Application Data
(60) Provisional application No. 61/609,133, filed on Mar. 9, 2012.

(51) Int. Cl. G09B 19/00

(52) U.S. Cl. CPC G09B 19/00
USPC 434/247

(57) ABSTRACT

A simple and practical clinical system and method to objectively assess and evaluate patient status and progress in different aspects of gait and functional performance is provided in which a complete functional clinical program that emphasizes the functional parameters relevant to gait or functional performance, such as walking, sit to stand (STS), standing, weight shifting ability, stair-climbing, the heel to toe gait pattern, symmetry in weight bearing, and adequate limb loading patterns is possible in the clinics and at home. An objective therapy regimen personalized to the patient is loaded into a handheld device to guide the patient through the exercises and to monitor compliance. Various forms of encouraging feedback are provided to the patient during the sessions. The therapy regimen may be updated remotely based on the patient's performance.

### CROSS-REFERENCE TO RELATED APPLICATIONS

The present application claims the benefit of the filing date of U.S. Provisional Patent Application Ser. No. 61/609,133, filed Mar. 9, 2012. The present application hereby incorporates the contents of that patent application by reference.

### FIELD OF THE INVENTION

The invention relates to systems and methods for brain re-training for ambulatory and/or functional performance therapy and, more particularly, to systems and methods for providing interactive biofeedback in accordance with an automated therapeutic training program that applies clinical rules to assess and monitor the patient's gait performance as well as to aid in the patient's recovery from lower limb injuries.

### BACKGROUND

Safe and efficient ambulation is a primary goal in rehabilitation, and gait training and re-education often form a major part of the rehabilitation regimen. Physical therapy focuses on strengthening functional movements and improving balance, gait and coordination, and improving skills needed for completing activities of daily living (ADL). Gait training is often divided into subgoals, such as standing balance, weight shifting, and symmetrical loading during walking. Optimal or even adequate weight bearing on the limb during walking or standing is not, however, always achieved. Often, the faulty limb-loading or weight-shifting patterns persist although there is adequate muscle strength and no pain or fear. Additional factors that may contribute to asymmetrical standing or walking are sensory disturbances, perceptual spatial disorders, and limited motor control. Achievement of optimal performance depends upon such factors as immediate knowledge of results, reinforcement, and repetition.

Osteoarthritis (OA) is a chronic degenerative joint disease that disables about 10% of people over the age of 60 and compromises the quality of life of more than 20 million Americans. The prevalence of knee OA increases with increasing age, with estimates of 10-15% in older adults, compared to 1.6-9.4% across all adults. To alleviate pain and disability associated with knee OA, over 470,000 total knee arthroplasties (TKA) are performed each year in the United States with future projections of more than 750,000 per year by 2030. Recovery of muscle strength and function in patients after TKA remains a major challenge in rehabilitation. In fact, the 2003 NIH consensus statement on TKA stated that “the use of rehabilitation services is perhaps the most understudied aspect of the preoperative management of TKA patients.” While TKA reliably reduces pain and typically improves activity levels in patients with knee OA, persistent deficits in functional mobility and muscle strength are ubiquitous and may persist for years. In addition, asymmetries in lower limb kinetics during weight bearing activity are present before and after TKA and are characterized by a decrease in loading of the operated limb.

Lower limb unloading is present in additional orthopedic or neurological disorders as well as in orthopedic injuries including:
Post joint arthroplasty
Fractures (i.e., hip, knee, tibia-fibula, ankle)
Knee ligament injuries
Ligament tears (Achilles tendon, ankle sprain, plantar fasciitis, etc.)
Amputations
   Lower limb unloading also may directly contribute to the persistent deficiencies in functional mobility and muscle function. In addition, loading asymmetry may contribute to increased incidence of other musculoskeletal problems resulting from excessively loading other areas such as the non-operated limb and lower back.

In providing rehabilitation to the orthopedics population, the general goal is to improve weight bearing toward full weight bearing on the injured limb. Such therapy is thus designed to:
Accelerate the process of arrival to correct and full weight bearing through positive feedback and knowledge of result;
Improve quality of gait and safe ambulation at discharge;
Prevent overload on the sound limb (second joint arthroplasty) using bilateral feedback;
Motivate participant adherence to exercise regimes (at home) by providing continual feedback, knowledge of results and the ability to track progress over time;
Accelerate to return to a safe independent ambulation; and
Report results of ambulatory status to therapist and third party payers and reduce the number of home visits.

Similarly, in providing rehabilitation to neurological populations (e.g., victims of stroke, incomplete spinal cord injury, traumatic brain injury, multiple sclerosis, Parkinson's disease, and cerebral palsy), a general goal is also to enhance the weight bearing on affected limbs. Therapy for neuro-rehabilitation is designed to:
Quantify various aspects of ambulatory status such as weight bearing, velocity, cadence, and the correct timing of gait;
Improve functional ability through improving weight bearing, gait pattern, gait speed and reduction of energy consumption in Activity of Daily Living (ADL) using a personal adapted training program;
Facilitate the improvement in functional ability by enhancing the process of re-learning motor functions such as standing up, walking outside, stairs, etc.;
Improve balance and reduce the risk of falls and ultimately improve quality of life;
Motivate participant adherence to exercise regimes (at the clinic and at home) by providing continual feedback, knowledge of results and the ability to track progress over time; and
Quantify patient functional improvements and safe ambulation in the patient's natural environment.

Also, therapy is provided to prevent overload complications post-surgery in orthopedic populations with weight bearing restrictions due to recovery from complicated fractures (i.e. tibial plateau, tibia/fibula, ankle), unsuccessful joint arthroplasty, osteotomies, amputations, knee ligament (ACL/PCL), joint infection, stress fractures, etc. In such cases, the goals in providing therapy are to:
Decrease the time for assessment of patients by providing immediate evaluation of patient ability;
Decrease the time spent with hospital staff that is highly trained professionals by providing confidence that other support hospital or family can provide equal assistance with the assistance of feedback features;
Train patients with limited weight-bearing accurately and consistently to physicians orders;
Decrease risk of re-injury to the affected limb resulting in further surgery or therapeutic treatment;
Motivate participant adherence to exercise regimes with weight bearing restrictions (at the clinic and at home) by providing continual feedback, compliance score and the ability to track compliance over time (compliance with therapy); and
Report results of training and monitoring to physicians for their consideration and reduce the number of physical therapist's home visits.

Following injury, patients start a prolonged process of evaluation, rehabilitation, and physical therapy with a focus on normal movement. Gait training and re-education often form a major part of the rehab regimen. The objectives of gait training are often divided into sub goals, such as standing balance, weight shifting, and symmetrical loading during walking. A baseline evaluation of patient performance in gait-specific activities such as stance, swing, walking practice, and stair-climbing practice allows the clinician or physical therapist to determine therapy goals and to evaluate treatment progress.

Numerous devices have been suggested in the prior art for monitoring gait performance by measuring weight bearing and providing biofeedback in the form of electrical or mechanical (vibration) stimulation, auditory and/or visual feedback when the patient applies too much or too little weight on a limb. For example, the weight bearing data may be collected using systems such as those described in U.S. Pat. Nos. 6,273,863 and 7,998,092 and then sent to a weight bearing biofeedback system to provide auditory and/or verbal feedback and/or a stimulation system that provides electrical or mechanical feedback. Other systems collect the gait data and send the data to a clinical monitor or a cell phone for display. While the gait performance data may be efficiently captured for providing biofeedback and for analysis by a clinician using such systems, objective clinical tools are lacking in the monitoring of gait performance progress for monitored use in the clinic or for home use. The achieved level of gait performance is a factor influencing post inpatient destination. Furthermore, it is likely to be a major factor in determining independence for community-based activities. Thus, it is important to measure the change in performance and not simply the achieved performance level. Change in gait performance may have different implications, depending on the initial status. For patients with relatively poor initial gait performance, a clinically significant gain may mean the difference between returning to a home setting or needing long term care. Alternatively, for patients with better initial gait performance, a large gain may mean the difference between living within a community-based support system or living independently.

The clinical and rehabilitation environments need a clinical tool with an “evidence based” approach that documents changes in body weight and foot placement, and temporal aspects of gait such as cadence, velocity, and stance and swing duration. These variables affect the patient's overall functional level, and therefore, they are useful indicators in the clinical environment. A “brain retraining system” for rehabilitation in clinics and at home of post inpatients with lower limb injuries is desired that targets this need and that provides an interactive biofeedback mechanism that can assess and monitor the patient's gait and functional performance as well as aid in the patient's recovery. The present invention addresses these needs in the art.

### SUMMARY

A simple and practical clinical system and method to objectively assess and evaluate patient status and progress in different aspects of ambulatory and/or functional performance is provided in which a complete clinical program that emphasizes the functional parameters relevant to ambulatory and/or functional performance, such as walking, sit to stand (STS), standing, weight shifting ability, stair-climbing, the heel to toe gait pattern, symmetry in weight bearing, and adequate limb loading patterns is possible in the clinics and at home. The system allows the clinician to assess the patient's gait and/or functional performance, establish an objective therapeutic program based on clinical rules that address the patient's needs, load the objective therapeutic program onto a clinical computer and/or handheld device for home use that provide biofeedback and track the patient's progress with respect to the established objective therapeutic regimen in the clinic and at home, and automatically update the objective therapeutic program based on the patient's performance.

Exemplary embodiments of the invention relate to systems and methods for providing ambulatory training and/or functional performance training to a patient. The system includes force pressure sensors (e.g., insoles including a plurality of independent, non-overlapping pockets inflated with air or liquid and pressure sensors responsive to pressure changes of the pockets in response to force pressure from the patient to determine weight forces at different positions on the patient's foot or feet such as described in U.S. Pat. No. 7,998,092) that are arranged to receive force pressure from one or both of the patient's feet while the patient is transferring from sit to stand, standing, walking, ascending/descending stairs or any of a number of other gait and/or functional performance assessments. A processor is programmed to control the inflation of the pockets and to guide ambulatory training and/or functional performance training of the patient in response to outputs of the plurality of pressure sensors. In particular, the processor is programmed to implement an objective therapeutic training method including the steps of:

performing a gait analysis and/or functional performance evaluation of the patient;

providing an objective therapy regimen to the patient based on the gait analysis and/or functional performance evaluation and predetermined clinical rules;

providing performance feedback and/or post-performance feedback to train the patient as to proper ambulatory process and/or functional performance process in accordance with the provided objective therapy regimen; and

monitoring the patient's compliance with the provided objective therapy regimen and/or progress in ambulatory status and/or functional performance.

In exemplary embodiments, the performance feedback is provided based on patient evaluation and the clinical rules, feedback thresholds that relate to patient body weight are calculated, and feedback location is set The performance feedback may be in a feedback modality including visual, audio, verbal, vibration, or a combination thereof and may be implemented in a handheld computing device that provides the performance feedback using feedback modalities of the handheld computing device. A clinical computer and/or the handheld computing device also may present displays that guide the user through the therapy regimen and that enable a therapist to vary force thresholds in the therapy as appropriate to modify the therapy regimen. In addition, the system may include a server that communicates data to/from the processor of the clinical computer and handheld computing device for remote compliance monitoring and/or progress monitoring of the patient and for providing remote updating of the therapy regimen by changing performance thresholds, durations, repetition, time in the goal, and the like.

In exemplary embodiments, the functional performance evaluation includes evaluation of patient response to sit to stand, standing, weight shift, squat, single limb support, step up, and/or stair ascending and/or descending exercises.

These and other characteristics of the invention will be apparent from the following detailed description.

### BRIEF DESCRIPTION OF THE DRAWINGS

The various novel aspects of the invention will be apparent from the following detailed description of the invention taken in conjunction with the accompanying drawings, of which:

FIG. 1 illustrates a minimal weight bearing unsmoothness graph for orthopedic cases including complicated fracture, stress/strain/tear of muscle, and pain, weakness, and acute stage fear.

FIG. 2 illustrates weight bearing data for a calcaneous fracture after fixation.

FIG. 3 illustrates a combined graph of weight bearing data for total hip replacement (THR).

FIG. 4 illustrates weight bearing data for an ACL restructure.

FIG. 5 illustrates weight bearing data for a lateral condyle (ORIF) of an ankle fracture.

FIG. 6A illustrates a sample insole and control unit for collecting gait and functional performance data and FIG. 6B illustrates an exemplary software display created by the analysis software of the invention.

FIG. 7 illustrates exemplary clinician guidelines for using the gait analysis and therapeutic device of the invention.

FIG. 8 illustrates an exemplary embodiment of an algorithm for providing a standing assessment.

FIG. 9 illustrates an exemplary embodiment of an algorithm for providing a sit to stand assessment.

FIG. 10 illustrates an exemplary embodiment of an algorithm for providing a walk-across assessment.

FIG. 11 illustrates an exemplary embodiment of an algorithm for providing a stairs assessment.

FIG. 12 illustrates a feedback location for the fore foot during a stairs ascending assessment.

FIG. 13 illustrates a “Select Area” function on the assessment result's graph on the display for building a training exercise.

FIG. 14 illustrates that the “Training” option becomes available if training is required according to the results.

FIG. 15 illustrates the interface the user sees when the user clicks on the training menu to open a built-in training program (1 or 2 exercises) that includes the exercise name, connectivity (online) feedback thresholds (lower and upper), and feedback location (entire, hind or forefoot).

FIG. 16 illustrates the brain re-training software building a personal training program for each patient.

FIG. 17 illustrates the flow of a training program in accordance with the methods of the invention.

FIG. 18 illustrates selection of the entire foot, hind foot, or forefoot from the feedback location drop down menu.

FIG. 19 illustrates a display for setting thresholds for biofeedback.

FIG. 20 provides an example where the patient does not reach the training goal and the therapist drags the threshold limits to a new area within the patient capabilities.

FIG. 21 provides an example of the new threshold limit selected in FIG. 20 by the therapist.

FIG. 22 illustrates detection of any increase or decrease of weight bearing from the hind foot or forefoot chambers above a fixed threshold as a start or end of a step, where any weight measurement below these thresholds defines as a noise and does not get into the calculation.

FIG. 23, stance phase reflects the period of time when the foot is in contact with the ground and the swing phase reflects the period of time when the foot is swinging forward.

FIGS. 24 and 25 illustrate measured values for weight bearing throughout the patient's gait.

FIG. 26 illustrates a sample of a sit-to-stand pattern.

FIG. 27 illustrates filtering of a sit-to-stand pattern that divides the graph into three time frames and takes the first and last phases (T1, T3) while ignoring the middle sector.

FIGS. 28 and 29 illustrate the peak values in weight bearing (T1, T3) that are set as the stand up and sit down points, respectively, where the time duration for each point and the average weight bearing between these two points is measured.

FIG. 30 illustrates the foot placement pattern during a stairs down exercise.

FIG. 31 illustrates the foot placement pattern of a stairs up exercise.

FIG. 32 illustrates an auto zero selection to eliminate all the unwanted area and to remain with only the represented steps.

FIG. 33 illustrates that use of bilateral measurement allows showing the graphs side by side (or one above the other) on the same chart.

FIG. 34 illustrates setting the bilateral option under the ‘Patient File’-‘Menu’-‘System Configuration’ of the user interface.

FIG. 35 illustrates user inflation of the insoles on both legs for taking measurements, as illustrated on the device display during use.

FIG. 36 illustrates selection of the bilateral function at the ‘Legs’ on the right end of the figure.

FIG. 37 shows the user display when setting the Operation button to collect session data on both legs.

FIG. 38 illustrates two file records created at the previous session when downloading session data to a computer.

FIG. 39 illustrates a bilateral report display for graph and numeric results.

FIG. 40 illustrates the ergonomic design of the inflation and control unit of the invention.

FIG. 41 illustrates an electrical pump that provides automatic inflation to accurately and automatically inflate the insole using one hand only (CVA Patient) to a specific pre-defined pressure level which is used for normal operation.

FIG. 42 illustrates the display during inflation of the insole and the visible threshold that advises the user when the inflation is completed.

FIG. 43 illustrates a basic block diagram of the inflation pump of FIG. 41.

FIG. 44 illustrates the flow chart of operation of the inflation pump.

FIG. 45 illustrates a sample display during inflation.

FIG. 46 illustrates an advanced calibration dialog of a sample calibration screen.

FIG. 47 illustrates a display notifying the user that the advanced calibration was successfully completed.

FIG. 48 illustrates a patient's sample personalized training program screen in accordance with the invention.

FIG. 49 illustrates transfer of the personal training program from the clinical PC/iPod/iPhone/iPad through the server or directly to the patient mobile iPod/iPhone/iPad.

FIG. 50 illustrates display screens for the handheld device in the clinic and patient modes.

FIG. 51 illustrates the layout of the application tabs for the handheld display.

FIG. 52 illustrates an exemplary flow of operation and exemplary displays during setup of the handheld device upon selection of the ‘Clinic’ tab by the clinician.

FIGS. 53A and 53B illustrate displays that are presented if the user has previously used the system and is set up with a user name and password.

FIG. 54 illustrates a display that may be presented to the clinician in order to search for patient data.

FIGS. 55A-55E illustrates displays that guide the clinician in providing information about the patient until the patient is found.

FIG. 56 illustrates displays that allow the user to track the inflation of the left, right, or both insoles to the desired pressures.

FIG. 57 illustrates a list of the therapy assessments that the patient and/or clinician may select.

FIGS. 58A-58F illustrate exemplary displays during an initial online assessment of the patient while walking (FIGS. 58A-58B), climbing stairs (FIG. 58C), single limb support (FIG. 58D), and standing (FIGS. 58E-58F).

FIGS. 59A-59K illustrate results/trends in the initial assessment of the patient FIGS. 60A-60K illustrate respective training displays that the user may use during implementation of the selected therapies.

FIG. 61 illustrates a sample display illustrating the personalized training options for the patient. visual feedback display.

FIG. 62 illustrates visual feedback on the patient's weight shift therapy.

FIG. 63 illustrates post-performance positive reinforcement visual feedback.

FIG. 64 illustrates that the user may select feedback modalities including visual, audio, verbal, vibration, or a combination thereof.

FIG. 65 illustrates a sample visual feedback display for sit-to-stand.

FIG. 66 illustrates a sample visual feedback display for weight shift.

FIG. 67 illustrates a sample visual feedback display for walking.

FIG. 68 illustrates that the verbal feedback may also be simultaneously displayed on the handheld device.

FIG. 69 illustrates the criteria for generating verbal feedback.

FIG. 70 illustrates verbal and visual feedback examples.

FIG. 71 illustrates a feedback display for static training exercises for an entire foot (i.e., standing and weight shift).

FIGS. 72A and 72B illustrate feedback displays for static training exercises for weight shift AP on the hind foot or forefoot.

FIG. 73 illustrates a feedback display for bilateral training

FIG. 74 illustrates an exemplary time in target (TIT) display designed to encourage the patient to stay in a designated weight bearing zone for x seconds until the circle changes color.

FIG. 75 illustrates a log book that is stored on a secure active server and tracks patient adherence to therapy, compliance with therapy program, and performance and automatic update of the program.

FIG. 76 illustrates the main components of the system including the therapist's server and web interface in accordance with the invention.

FIG. 77 illustrates a sample patient logbook of exercises name, duration, and compliance scores.

FIG. 78 illustrates a simple presentation of a trend graph showing the progress by week.

FIG. 79 illustrates a simple presentation of a trend graph showing the progress of weight loading.

### DETAILED DESCRIPTION OF ILLUSTRATIVE EMBODIMENTS

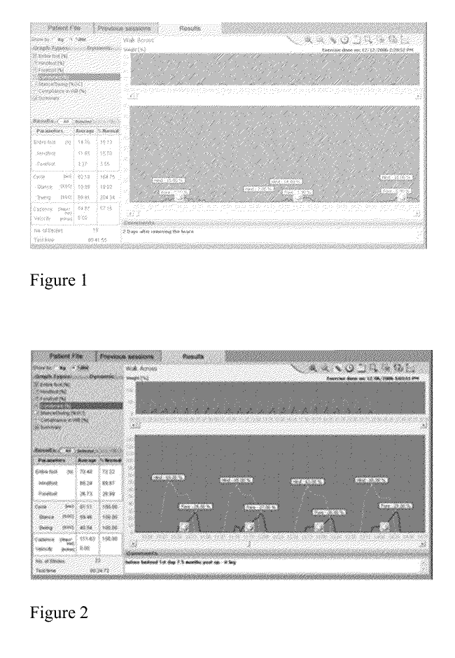

The invention will be described in detail below with reference to FIGS. 1-79. Those skilled in the art will appreciate that the description given herein with respect to those figures is for exemplary purposes only and is not intended in any way to limit the scope of the invention. All questions regarding the scope of the invention may be resolved by referring to the appended claims.

The brain re-training system described herein detects patient capabilities in low and high level functional activities—Activities of Daily living (ADL) such as sit-to-stand (STS), standing, walking and stairs. The system detects the weight shift loading pattern in STS (heel to toe movement), total loading of peak forces of the affected side and in standing (location of weight bearing—backward or forward), and total loading on the affected leg. The system detects gait pattern and deviation in different pathologies, including post-operative fractures, joint replacements (THR, TKR), knee-joint ligaments reconstructions (ACL, MCL, and meniscus), Achilles tendon, ankle injuries, calcaneus fractures, amputees, and neurological populations (“Stroke”—Cerebral Vascular Accident (CVA), multiple schlerosis (MS), Parkinson's, and Cerebral Palsy (CP). The therapist reviews this data and then programs the system to provide objective therapy regimens including personalized threshold and other therapeutic parameters to address the patient's needs. The objective therapy regimen is preferably programmed into a handheld unit that the patient takes home for home therapy. The system monitors the patient's compliance and provides the compliance data back to the therapist's server, which also allows the therapist and other doctors to monitor the patient's progress and to remotely update the objective training regimen. The process starts by providing a clinical gait evaluation.

### Clinical Gait Evaluation

There may be any of a number of problems with the patient's gait. The system described herein permits the clinician to assess the gait condition and then to prescribe the appropriate therapy regimen for the patient to rehabilitate to a normal gait pattern. Several such gait patterns are described below.

Antalgic Gait

Antalgic gait is the most common pattern observed in individuals with painful hips, post fractures, osteoarthritis, and joint reconstruction. Antalgic gait is characterized by avoiding weight bearing, heel strike loading, and a decrease in the stance phase on the affected side to prevent excess loading of the joint.

In post knee replacement patients with anterior knee pain, intra-articular effusion meniscal tear, loose body, or inflammatory synovitis, the painful knee is maintained in slight flexion throughout the gait cycle, which reduces the tension on the knee joint capsule. The post-surgical gait pattern involves the avoidance of heel strike, instead toe walking on the affected side. The quadriceps avoidance gait occurs in those who have suffered an injury to their anterior cruciate ligament (ACL), and they suffer from an ACL deficiency. Painful conditions of the foot and ankle from trauma, inflammatory disorders, degenerative arthritis, and so forth, can cause a person to limit weight bearing on the affected area, and normal heel-to-toe motion is often lost.

Problems of the hind foot, particularly of knee pathologies, will produce a similar gait pattern (e.g., elimination of heel strike and a promotion of toe contact during stance). These problems include, among others, injuries of the knee ligaments, and stress fractures of the ankle. An antalgic or avoidance gait with a decrease in heel loading is the typical pattern. In contrast, problems of the forefoot (sprain, fracture, arthritis, metatarsalgia, etc.) can result in an antalgic gait that minimizes forefoot loading by decreasing plantar flexion during both the stance phase and push off People with these problems tend to increase loading on the heel and hind foot while shortening the forefoot loading time.

Joint contractures of the ankle are often seen after trauma, immobilization, and neurologic problems affecting the muscles of the ankle and foot. The most common contracture is of the gastrocsoleus complex or “heel cord.” There is a loss of both normal heel contact and heel-to-toe motion along with exaggerated hip and knee flexion during the swing phase to ensure toe clearance of the ground.

Neurological-Post “Stroke” Gait

The walking pattern of patients post CVA is characterized by problems with the generation, timing, and grading of muscle activities. Gait speed, stride length, and cadence values are lower than normal. Common kinematics deviations during the stance phase of the gait cycle include decreased hip extension angles, changed knee extension, and decreased plantar-flexion angles, all of which influence the symmetry and sequencing of the gait pattern. Compensatory changes include hip hiking due to reduced knee flexion of the stance leg, a decreased lateral shift over the affected side, no heel strike after plantar flexion of the ankle, and recurvatum of the affected knee.

When the leg is affected by mild weakness, the gait abnormality will be noted at heel strike and results in the loss of plantar flexion control. The heel strike to foot-flat phase occurs rapidly, and the foot may slap at heel strike, as eccentric control of the dorsiflexors is decreased. In severe weakness or paralysis, the foot will fall into plantar flexion during swing phase, presenting as foot-drop. Heel strike is absent, and during walking the leg descends toes first or with the entire foot. This can cause a relative lengthening of the limb, compensated for by exaggerated hip and knee flexion to allow for toe clearance (step page gait).

Amputees' Gait

Amputees exhibit marked differences between affected and unaffected limbs. Because of their prosthetic limbs, amputees have asymmetrical gaits. They spend more time in stance on their intact limb and load their prosthetic limb less during natural cadence walking. As a consequence, the unusually large forces applied to the intact limb can lead to pain and joint degeneration. The loading asymmetry may be expressed in terms of the vertical ground reaction force. Both the normal gait phase sequence and kinematics symmetry might be affected by deformities, muscle weakness, impaired motor control, and pain. Gait deviations (Examples):

FIG. 1 illustrates a minimal weight bearing unsmoothness graph for orthopedic cases including complicated fracture, stress/strain/tear of muscle, and pain, weakness, and acute stage fear. In the case of FIG. 1, the orthopedic case is a tear in the tibialis posterior.

Low Weight Bearing on Forefoot

Low weight bearing on the forefoot occurs for orthopedic cases including, after fixation of the foot, fractures and ankle sprain shortening of the plantar fascia, as well as Osteoarthritis (OA) of the foot. Low weight bearing on the forefoot occurs for neurological cases including weakness of the gastrocnemius and reduced sensation in the forefoot. Low weight bearing on the forefoot may also occur for normal cases as a result of walking on a treadmill.

FIG. 2 illustrates weight bearing data for a calcaneous fracture after fixation.

Low Weight Bearing on Hind Foot

Low weight bearing on the hind foot occurs for orthopedic cases including various knee pathologies-Ligament constructions, amputations, and total hip replacement (THR)/total knee replacement (TKR). Low weight bearing on the hind foot occurs for neurological cases including weakness of the dorsi flex and spasticity of the plantar flex.

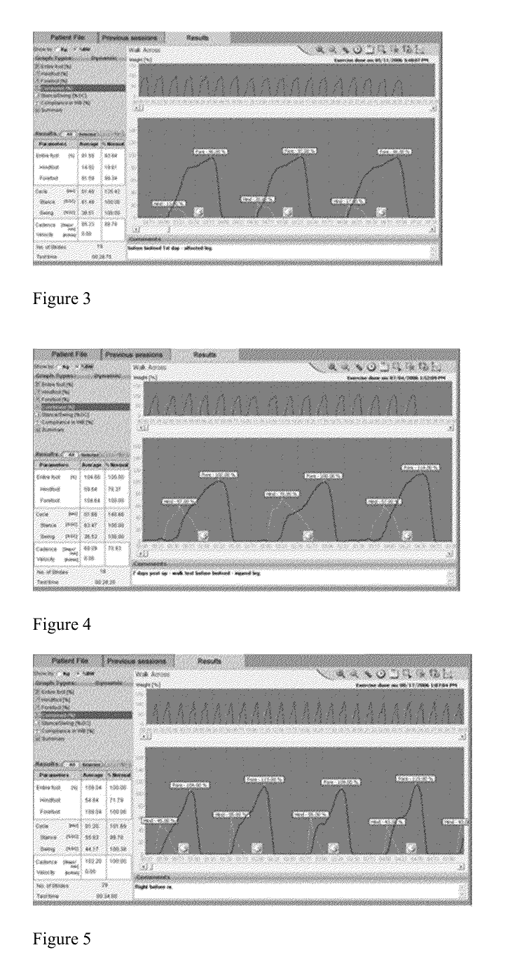

FIG. 3 illustrates a combined graph of weight bearing data for THR, while FIG. 4 illustrates weight bearing data for an ACL restructure.

High Weight Bearing on Entire Foot, Hind Foot or Forefoot

High weight bearing on the forefoot may occur as a result of Anterior Knee Pain (AKP or ankle Fractures, while high weight bearing on the hind foot may occur due to reduced motion control (ataxia) and reduced sensation.

FIG. 5 illustrates weight bearing data for a lateral condyle (ORIF—Open Reduction and Internal Fixation) of an ankle fracture.

### Brain Re-Training Functional Therapy

Brain re-training functional therapy in accordance with the invention addresses the patient's gait diagnosis with a therapy including four main components:
Flexible, force-sensing insole;
Pressure Sensors;
Wireless, portable, miniature microprocessor control unit for data relay and feedback generation; and
Software for analysis, visual display and biofeedback, and storage of patient performance data.
   As will be explained in more detail below, these components form a system that may be used by a clinician to perform an analysis of the patient's gait, prescribe an objective therapy regimen to address the gait diagnosis, monitor the patient's compliance with the prescribed therapy regimen, and adjust the therapy regimen based on the patient's performance.

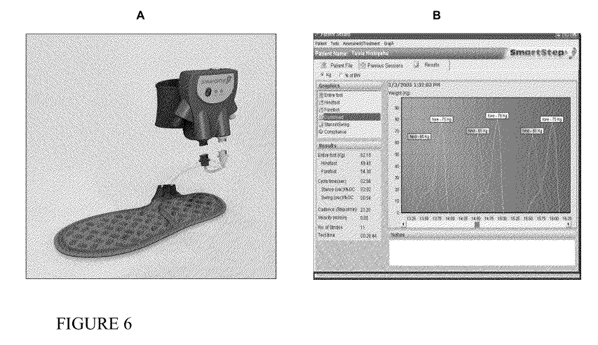

FIG. 6A illustrates a sample insole and control unit for collecting gait and functional performance data and FIG. 6B illustrates an exemplary software display created by the analysis software of the invention. In an exemplary embodiment, an inflatable insole of the type described in U.S. Pat. No. 7,998,092 is connected to two pressure sensors that measure the force applied under the heel and forefoot of the affected limb in a manner similar to that described in U.S. Pat. No. 7,998,092, the contents of which are incorporated by reference herein. The data is received and analyzed by the miniature, portable control unit, which is worn around the ankle, although the control unit could also be worn on the patient's belt or carried. Data is transmitted to a processor of the control unit that runs the analysis software. The control unit may also maintain the patient's medical records and otherwise function as an assessment, monitoring, and therapy tool as described herein.

The control unit may be programmed to operate in at least two modes. In a first mode, clinical gait or functional performance analysis, the control unit collects and analyzes data from the insole to aid the clinician in establishing the appropriate therapy regimen or to otherwise assess the patient's current condition. In a second mode, the control unit provides feedback training to the patient and monitors the patient's compliance with a software-driven therapy regimen with pre-programmed objective therapy thresholds.

During clinical gait analysis, data from the control unit is provided to a display on a PC, laptop, handheld computer, smart phone or the like, preferably wirelessly, for presentation to the clinician and/or the patient. The software application on the display device graphically displays an analysis of the patient's data, including body weight bearing, gait pattern, velocity, cadence, the correct timing of gait, and the like as collected during a gait analysis or function performance evaluation. Clinicians and physical therapists are able to quantify the patient performance, determine therapy goals, and evaluate treatment progress using the gait analysis data.

During feedback training, the control unit is programmed to provide the patient with real-time auditory and/or vibration indications of correct or incorrect gait performance according to the specific patient's prescribed therapy regime as programmed into the control unit's software by the therapist. Feedback training in the clinic or at home guides patients as they strive for correct gait performance and function. The software also is programmed to provide auditory and/or verbal and/or visual real time feedback to the patient on a handheld computer or smart phone operated by the patient.

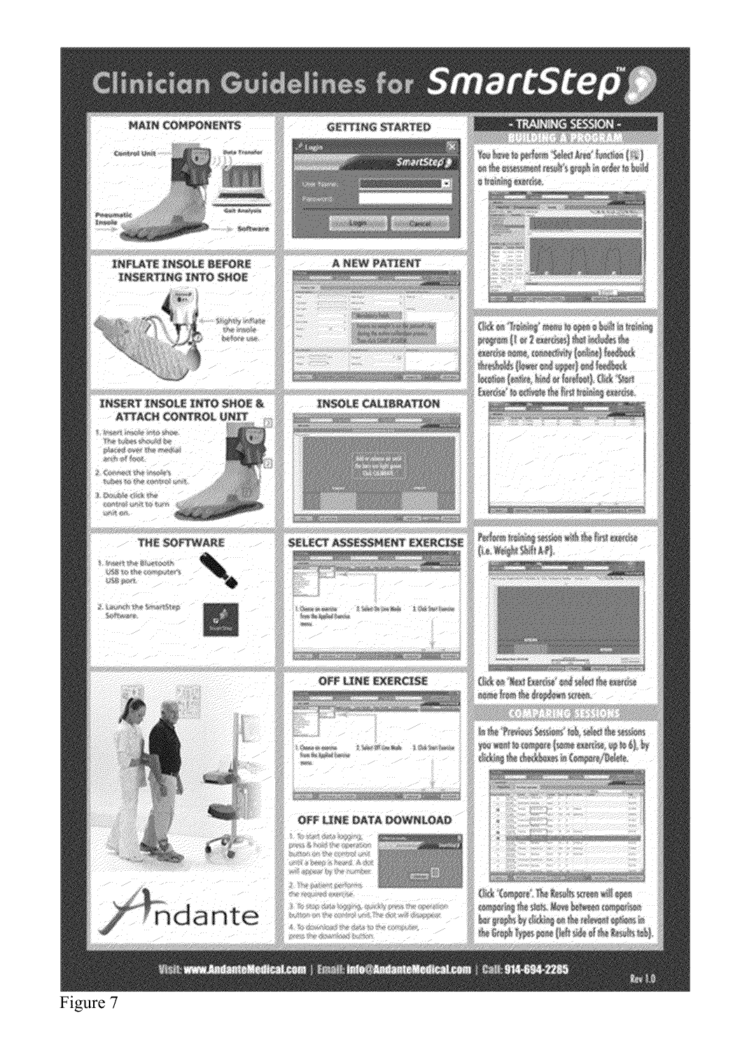

FIG. 7 illustrates exemplary clinician guidelines for using the gait analysis and therapeutic device of the invention. As illustrated, the pneumatic insole is inflated, the tubes are connected, and the insole is placed in the patient's shoe. The control unit is strapped to the patient's ankle. Data collected by the control unit is wirelessly transferred (e.g., via Bluetooth) to a Bluetooth USB inserted into the USB port of a PC, laptop, handheld computer, smart phone, or other display device running the display software for display of the gait analysis data. To begin operation, the control unit is turned on and the display software is launched. The software then guides the clinician through setup of the new patient by collecting patient data, calibrating the insole, and selecting the patient's assessment exercise(s). The patient then performs the exercise and the data is collected. The collected data is displayed to the therapist so that the clinician may determine the appropriate therapy regimen for the patient. The software loaded into the control unit or provided as part of the display software then guides the therapist through building a therapy regimen (program) for the patient by establishing weight bearing thresholds, exercises, repetition, timing, feedback modalities, etc. for the patient. This process is described in the next section.

Brain Re-Training Functional Therapy—Clinical “Knowledge System”

Based on clinical knowledge and experience gathered in the field and built into the software of the invention, the software automatically builds a functional training program according to the patient gait deviation or capabilities in Activity of Daily Living (ADL) and modifies the program (repetition, time, time in the target, etc.) during the training period at home using the software through a secured server.

The software has a built-in “clinical rules algorithms” for building a functional training program based on the evaluation outcomes in all the functional activities (static and dynamic). Based on the clinical rules algorithm, the software automatically sets a functional training program that includes the specific exercise with the calculated feedback thresholds (lower and upper) that refers to patient body weight and specific feedback location. This automatic capability to set the specific exercises with specific thresholds and feedback location simplifies the operation and the ability to move quickly from evaluation to treatment. The therapist thus no longer needs to analyze the evaluation results and to calculate and set the treatment thresholds and feedback location manually which is time consuming in the overloaded physical therapy environment.

Clinical Rules Algorithms

The following flow charts and tables show the clinical rules criteria for exemplary system exercises.

Standing Exercise:

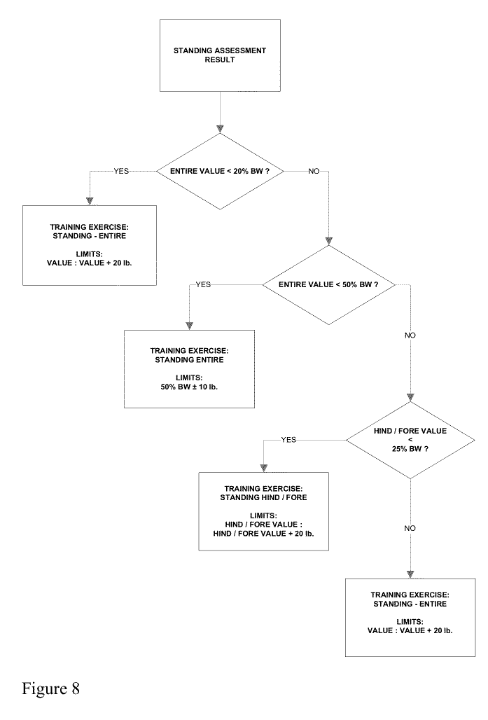

FIG. 8 illustrates an exemplary embodiment of an algorithm for providing a standing assessment. As illustrated, the standing assessment proceeds as follows:

Standing

Entire Value<20% body weight (BW)→Treatment:

Standing Exercise−(Lower limit=Value)−(Upper limit=Value+20 lb.)
Feedback Location−Entire foot

20% BW<Entire Value<50% BW→Treatment:

Standing Exercise−(Lower limit=50% BW−10 lb.)−(Upper limit=50% BW+10 lb.)

Feedback Location−Entire foot

Entire Value≧50% BW but Hind/Fore<25% BW→Treatment:

Standing Exercise−(Lower limit=H/F Value)−(Upper limit=H/F Value+20 lb.)

Feedback Location−Hind foot/Fore foot

Entire Value≧50% BW (Hind/Fore≧25% BW)→Treatment:
Standing Exercise−(Lower limit=Value)−(Upper limit=Value+20 lb.)

Feedback Location−Entire foot

During the standing assessment, the software analyzes that data (Weight Bearing average and peak in pounds (lbs.) or percentage body weight (% BW) on the entire foot, hind foot and forefoot). If the value of the weight bearing on the entire foot is below 20% of patient body weight, the software sets a training exercise in Standing while the thresholds are: Lower Threshold is the measured value and is the lower limit, and the Upper Threshold is the measured value plus 20 lb. The feedback location will be on the entire foot.

If the software does not go to the first condition, this means that the entire value is above 20% of the patient body weight. The software checks if the entire value is below 50% BW of the patient. If it is below 50% BW, it means that the measured entire value is above 20% BW and below 50% BW. In this case, it is desirable to work with the patient on reaching symmetrical standing. The training exercise will be Standing while the lower and upper limits thresholds will be around the 50% BW target goal for symmetrical loading.

If the measured entire value is above 50% BW, which means that the patient can reach symmetrical loading and shift more weight on the affected side, the software checks the hind foot and forefoot. If the hind foot or forefoot are less than 25% BW, the software checks which of the sections is below the 25% BW and applies a standing exercise with limits of measured hind foot or forefoot value as the lower limit and hind foot or forefoot value as +20 lb. for the upper limit.

If this condition does not apply, it means that both the entire measured value is above 50% BW and both Hind/Fore measured values are above 25% BW. In this case, it is desirable for the patient to apply even more weight on the foot so the training exercise will be standing with a limit of the entire measured value as the lower threshold and the entire measured value+20 lb. as the upper threshold. The table below summarizes the conditions of standing exercise:

| | | TRAINING | | | |
|---|---|---|---|---|---|
| | | | | LOWER | |
| | CONDITION | EXERCISE | FEEDBACK | Threshold | UPPER Threshold |
| 1 | ENTIRE < 20% BW | STANDING | ENTIRE | VALUE | VALUE + 20 lb. |
| 2 | 20% BW < ENTIRE < 50% BW | STANDING | ENTIRE | 50% BW − | 50% BW + 10 lb. |
| | | | | 10 lb. | |
| 3 | ENTIRE > 50% BW | STANDING | HIND/ | VALUE | VALUE + 20 lb. |
| | HIND/FORE < 25% BW | | FORE | | |
| 4 | ENTIRE > 50% BW | STANDING | ENTIRE | VALUE | VALUE + 20 lb. |
| | HIND/FORE > 25% BW | | | | |

Sit to Stand (STS) Exercise

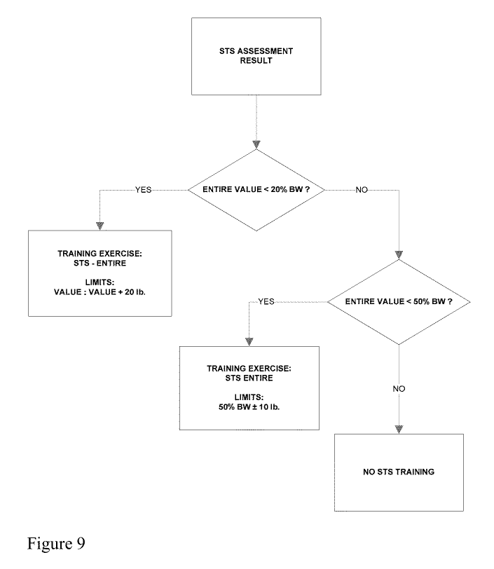

FIG. 9 illustrates an exemplary embodiment of an algorithm for providing a sit to stand assessment. As illustrated, the sit to stand assessment proceeds as follows:

Sit to Stand

Entire Value<20% body weight (BW)→Treatment:

Sit to Stand Exercise−(Lower limit=Value)−(Upper limit=Value+20 lb.)

Feedback Location−Entire foot

20% BW<Entire Value<50% BW→Treatment:

Sit to Stand Exercise−(Lower limit=50% BW−10 lb.)−(Upper limit=50% BW+10 lb.)

Feedback Location−Entire foot

When the software analyzes the data of a Sit-to-Stand (STS) assessment, if the value of the entire foot is below 20% BW of the patient, the software generates a single STS training exercise with feedback locations on the entire foot. The measured value on the entire foot is set as the lower threshold and the measured value of the entire foot+20 lb. is set as the upper threshold.

If the first condition does not apply, it means that the value of the entire foot is above 20% BW and the software checks if it is also above 50% BW. If so, no further training exercise will be generated. If it is not above 50% BW, it means that the measured value on the entire foot is between 20% BW and 50% BW. The software generates a training exercise of type STS with lower and upper thresholds as 50% BW±10 lb., respectively, while the feedback location is set on the entire foot. The table below summarizes the conditions of the sit to stand exercise:

| | | TRAINING | | | |
|---|---|---|---|---|---|
| | CONDITION | EXERCISE | FEEDBACK | LOWER | UPPER |
| 1 | ENTIRE < 20% BW | STS | ENTIRE | VALUE | VALUE + 20 lb. |
| 2 | 20% BW < ENTIRE < 50% BW | STS | ENTIRE | 50% BW − | 50% BW + 10 lb. |
| | | | | 10 lb. | |
| 3 | ENTIRE > 50% BW | NONE | — | — | — |

Walk-Across Exercise

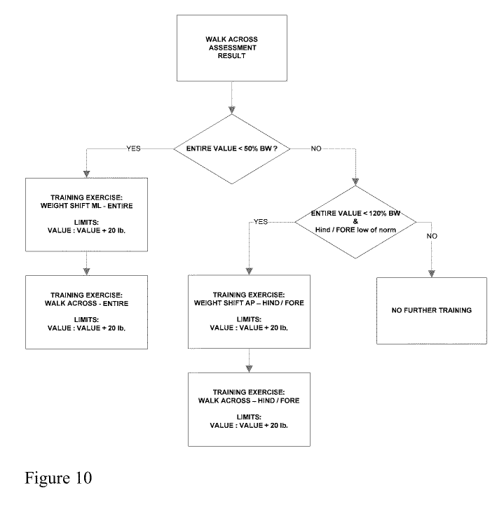

FIG. 10 illustrates an exemplary embodiment of an algorithm for providing a walk across assessment. As illustrated, the walk across assessment proceeds as follows:

Walk across

Entire Value<50% body weight (BW)→Treatment:

Weight Shift M-L Exercise−(Lower limit=Value)−(Upper limit=Value+20 lb.)

Feedback Location−Entire foot

Walk Across Exercise−(Lower limit=Value)−(Upper limit=Value+20 lb.)

Feedback Location−Entire foot

50%≦Entire Value<120% BW, but low BW on H/F→Treatment:

Weight Shift A-P Exercise—

(Lower limit=H, F Value)−(Upper limit=H, F Value+20 lb.)

Feedback Location−Hind/Fore

Walk Across Exercise—

(Lower limit=H, F Value)−(Upper limit=H, F Value+20 lb.)

Feedback Location−Hind/Fore

When the software analyzes patient data in the walk across assessment, the first thing that the software checks is the weight bearing on the entire foot. As long as the entire foot weight bearing is not low (the value is less than 50% BW), the software will generate a program that includes 2 stages—the first stage includes static exercise (weight shift medio-lateral) to train the patient to shift his/her weight and to increase his/her weight bearing on the entire foot, and the second stage includes a walk across exercise with auditory feedback that encourages the patient to increase his/her body weight on the affected side.

When the values of the entire foot are above 50% BW, the software checks the foot placement gait pattern of the walking—the hind foot and/or the forefoot loading pattern. If the hind foot and or the forefoot weight bearing values are below the expected percentage of normal value (normal values are saved and are in the system for comparison), there will be a training program in 2 stages—first stage to enhance weight bearing on the hind foot or forefoot with weight shifting anterior-posterior (AP), and the second stage with walking and getting to feedback to the hind foot or to the forefoot to enhance heel strike or push off.

If both are below the normal value, the software will build a program that includes 4 training exercises, two for each hind foot/fore foot. The training exercises will consist of a static exercise of type weight shift AP for hind/fore foot and walking on the hind/fore foot. The table below summarizes the conditions of the walk across exercise:

| | | TRAINING | | | |
|---|---|---|---|---|---|
| | CONDITION | EXERCISE | FEEDBACK | LOWER | UPPER |
| 1 | ENTIRE < 50% BW | WEIGHT | ENTIRE | VALUE | VALUE + 20 lb. |
| | | SHIFT ML | | | |
| | | WALK | ENTIRE | VALUE | VALUE + 20 lb. |
| | | ACROSS | | | |
| 2 | 50% BW < ENTIRE < 120% BW | WEIGHT | HIND/ | VALUE | VALUE + 20 lb. |
| | | SHIFT AP | FORE | | |
| | | WALK | HIND/ | VALUE | VALUE + 20 lb. |
| | | ACROSS | FORE | | |

Stairs Exercise

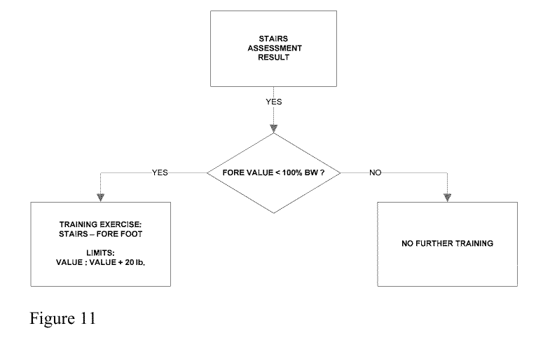

FIG. 11 illustrates an exemplary embodiment of an algorithm for providing a stairs assessment. As illustrated, the stairs assessment proceeds as follows:

Stairs Ascending

Fore foot Value (Second Peak)<100% BW→Treatment:

Stairs Exercise−(Lower limit=F Value)−(Upper limit=F Value+20 lb.)

Feedback location−Fore foot

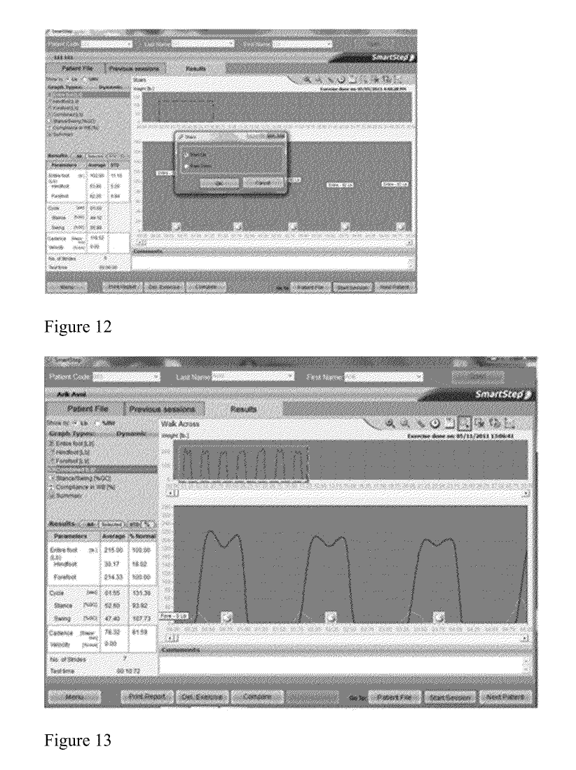

FIG. 12 illustrates a feedback location for the fore foot during a stairs ascending assessment.

Stairs Descending

Fore foot Value (First Peak)<100% BW→Treatment:

Stairs Exercise−(Lower limit=F Value)−(Upper limit=F Value+20 lb.)

Feedback Location−Fore foot

In a stairs assessment exercise, the software checks the values of the forefoot while ascending or descending. In ascending stairs, the second peak is higher and in descending stairs the first peak is higher. There will be separate training for up/down stairs. The fore foot loading should be at least 100% of body weight. The table below summarizes the conditions of the stairs exercise:

| | | TRAINING | | | |
|---|---|---|---|---|---|
| | CONDITION | EXERCISE | FEEDBACK | LOWER | UPPER |
| 1 | FORE < 100% BW | STAIRS | FORE | VALUE | VALUE + 20 lb. |
| 2 | FORE > 100% BW | NONE | — | — | — |

### Automatic Brain Re-Training Program

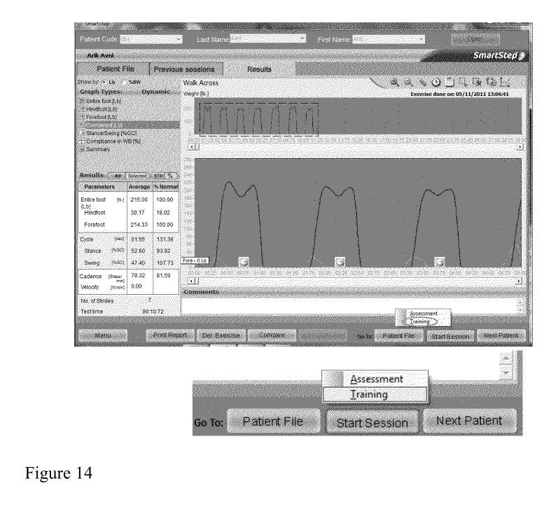

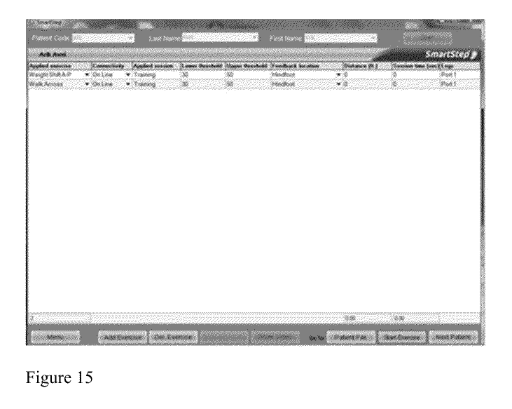

The gait data acquired during assessments of the type just described using the device of the invention are analyzed and presented to the therapist and/or patient using the system analysis and display software. From the display of the gait data as shown in FIG. 13, the therapist is given the option to select a “Select Area” function on the assessment result's graph on the display for building a training exercise. The user is then guided by the software through the process of building a training exercise. As shown in FIG. 14, the “Training” mode option is selected instead of the “Assessment” mode option if required according to the results. The user selects the training menu option to open a built in training program (1 or 2 exercises) that includes the exercise name, connectivity (online) feedback thresholds (lower and upper), and feedback location (entire, hind or forefoot) as shown, for example, in FIG. 15.

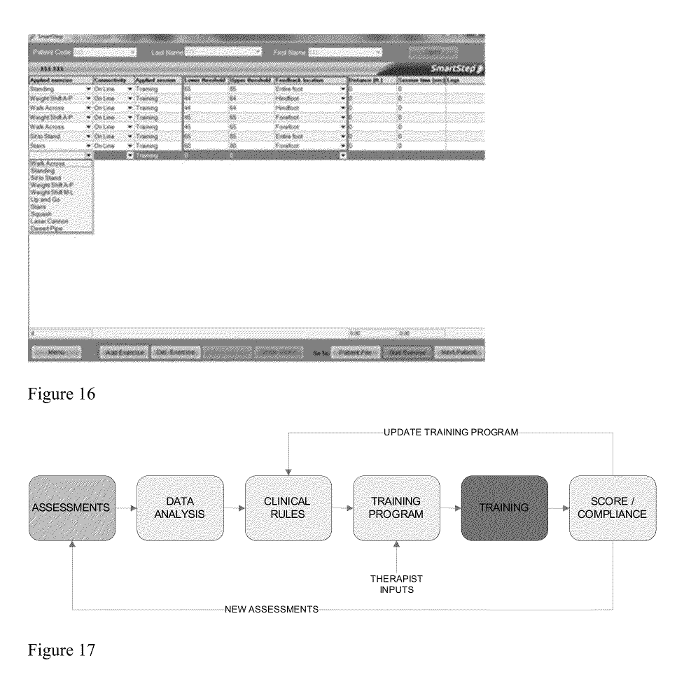

As illustrated in FIG. 16, the brain re-training software builds a functional personal training program for each patient. As the patient performs assessment exercises, the software analyzes the data and according to the patient capabilities results builds a set of training exercises with the required weight thresholds and feedback locations—entire foot, hind foot or the forefoot according to the gait pathology. The training program is saved in the system, and the therapist has the ability to modify each of the training program components: exercise, threshold, feedback location. In addition, the therapist can change the thresholds in real time during the session by dragging the threshold limits up and down on the feedback display.

A training program is saved for each patient at the software data base using a patient unique software ID number, and the therapist can initiate the program in each of the following treatments. The software will update the program according to the next evaluation outcomes.

Training program includes the following:

1. Exercise type

2. Lower and Upper Thresholds

3. Feedback location—Hind foot/Forefoot/Entire-foot

4. Exercise duration

In addition the training program includes:

1. Right/Left foot

2. Duration—the entire workout duration (weeks)

3. Frequency—per day/week

4. Repetitions—number of repetition during each of the training exercises Repetition success=Compliance score

5. Time in the target

A number of recommended repetitions are generally set for the first week and last week according to patient base capabilities, where on the last week the number of repetitions is increased.

Also, in several training exercises (mainly in static exercises), a Time in Target (TIT)/sec value is set. This value indicates that the patient should keep loading his affected side between the thresholds target for X seconds to increase training efficiency.

In exemplary embodiments, several feedback features are provided at the following locations and times set by the therapist:

On the entire foot, hind foot and forefoot;

Auditory, Visual (PC/iPod), Vibration (control unit/iPhone), Verbal (iPod/iPhone);

Inside the limits (lower limit one signal, upper limit additional signal);

Feedback to hind foot, feedback to forefoot, feedback to hind foot and forefoot simultaneously;

Combined modalities: feedback to the entire foot (audio) and for hind foot and forefoot (Visual) work on entire WB and foot loading location—heel versus forefoot;

Bilateral approach: feedback to right foot one signal, feedback to left foot, and feedback to both;

Frequency—Walking/Stairs: every step 1:1, every 3 steps 1:3 . . . 1:5;

Static exercises—STS/Standing: every 1 sec/2 sec . . . ; and

Immediate when hit the target/post completion of the exercise.

Of course, feedback may be provided at other times and locations in other modalities as desired.

A Sample Training Exercise:

| | | Duration | Lower | Upper | Feedback | | TIT |
|---|---|---|---|---|---|---|---|
| | Exercise | [min:sec] | Limit [lb.] | Limit [lb.] | Location | Repetitions | [sec] |
| □ | Standing | 01:00 | 140 | 160 | Entire | 10 | 2 |
| □ | Sit-to-Stand | 01:00 | 140 | 160 | Entire | 5 | 3 |
| □ | Weight Shift | 01:00 | 140 | 160 | Entire | 10 | 3 |
| | ML | | | | | | |
| □ | Walk Across | 02:00 | 150 | 170 | Entire | — | — |
| □ | Stairs | 01:00 | 80 | 100 | Fore | 5 | — |

From the saved training program, the therapist can decide which of the exercises to perform. Training program parameters can be modified manually by the therapist (according to his expertise and goals) or automatically within a certain range based of clinical rules for updating the program. The automatic update guarantees that the new parameters will be clinically reasonable. The software analyzes the results (patient compliance score) and updates the program according to difficulty level to adjust patient trend—improvement/plateau or not comply/deterioration. The difficulty level includes increasing the goal, number of repetitions, exercise time, and time in the target. In any update of the training program, a notification will be sent to the therapist (while the patient is in the clinic or at home) by the server that maintains the patient data for all of the therapist's patients.

### Training Program Flow

FIG. 17 illustrates the flow of a training program in accordance with the methods of the invention. As illustrated in FIG. 17, the training program includes a first evaluation meeting that starts with several assessments exercises. The software analyzes the results of all of the evaluation exercises (e.g., Sit to Stand, Standing, Walking, Stairs) and, according to the clinical rules proposed, a personalized functional training program is automatically set for all 4 exercises. The training program is approved by the therapist who has the ability to modify the training program if required. The patient then performs the training program while the software analyzes the data. The results of the training in terms of score/compliance are analyzed by the software through another set of clinical rules and the training program is updated automatically. From time to time, the patient can return to the clinic for a follow up evaluation, which again can lead to an update of the training program.

As an example, after TKR/THR/ACL/AKP, the software will distinguish decreased loading on the heel during the heel strike-loading response and emphasize the treatment toward enhancement of weight bearing on the hind-foot in weight shift AP with visual feedback or interactive games and during walking with auditory feedback. For Stroke/MS/Amputee patients, the software may distinguish between decreased loading on the hind-foot at heel strike—loading response versus loading on the forefoot at Terminal Stance and will build a training feedback program accordingly. In addition, the software will measure both legs and alternate the feedback for both sides in order to increase the symmetry between the limbs and to prevent overloading on the less affected side. At any point, the user can override the personalized program proposed by manually adding more exercises.

Manipulation of the Training Program

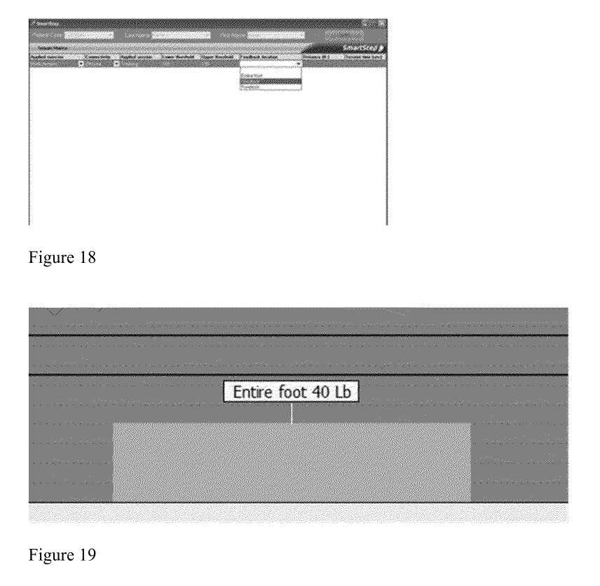

As illustrated in FIG. 18, the user can delete the actual built training program by pressing “delete exercise” and set manually the training parameters as follows:

1. Click in the Lower threshold and Upper threshold fields to define the desired weight range.

2. From the Feedback location drop down menu choose entire foot, hind foot, or forefoot. The Applied Session changes automatically from Assessment to Training.

3. Click Start Exercise to begin the session. The control unit display changes automatically to training mode (mode 2).

Whether the entire foot, forefoot, or hind foot is selected depends on the patient's needs. In each case, the control unit beeps once when the patient enters the desired weight range as defined in the lower and upper threshold fields (see below) and emits multiple beeps to indicate that the patient has exceeded the defined maximum weight-bearing limit. This feedback is set as follows:

Select entire foot if you want the control unit to beep once when the patient enters the desired weight range for the forefoot and hind foot combined.

Select forefoot if you want the control unit to beep once when the patient enters the desired weight range with the forefoot only.

Select hind foot if you want the control unit to beep once when the patient enters the desired weight range with the hind foot only.

To delete an exercise, the user clicks to select the row he/she wants to delete and presses the delete exercise button. When the user has finished defining the exercise in the workout plan design screen, the user clicks start exercise to begin.

### Manual Adjustment of Feedback Thresholds Online

The therapist can update the feedback thresholds while performing the training exercise online to match the patient's ability with feedback thresholds whereby the patient does not arrive to the goal or load above the defined goal. For example, in the display of FIG. 19, on the online exercise the user points the mouse at one of the threshold lines at the top of the figure. The user clicks the mouse (left) and drags the limits up/down to set new thresholds. Once the user releases the mouse press, a new training exercise record will start and the training thresholds for this exercise will be modified (training program will be updated as well).

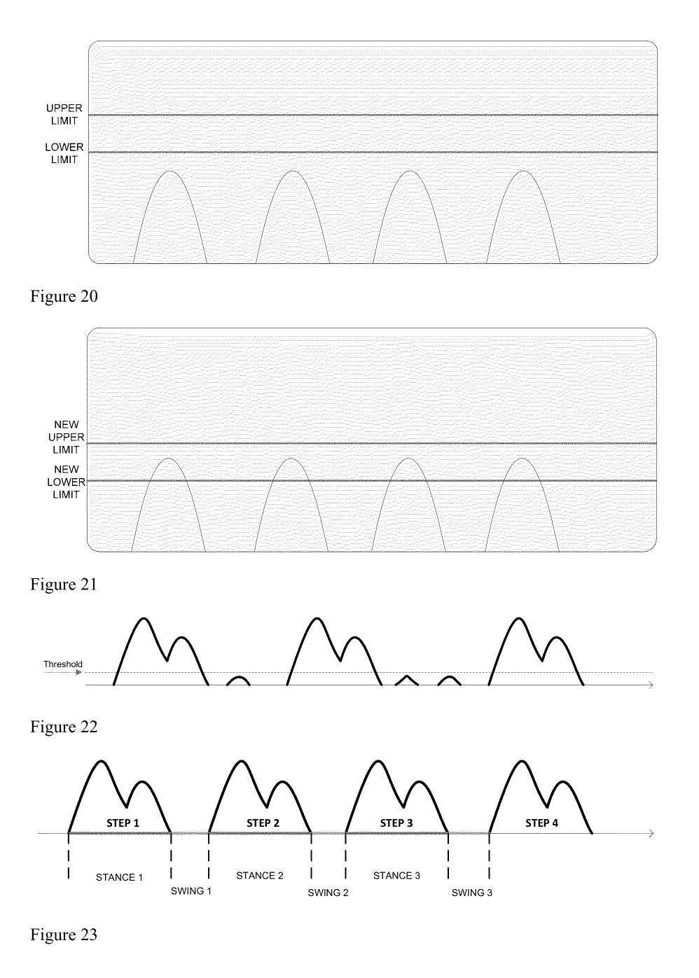

FIG. 20 provides an example where the patient does not reach the training goal and the therapist drags the threshold limits to a new area (FIG. 21) within the patient capabilities. Changing the visual thresholds limit on the screen will change the thresholds of the auditory feedback as well which are sent to the control unit and the patient can practice with both visual and auditory feedback according to his/her actual ability.

FIGS. 20 and 21 display the situation where the initial thresholds limit was set above the patient ability; however, there are also situations where the thresholds limits are set below the patient ability and there is a need online to elevate the thresholds toward the patient ability level. Any change to the training limit during the online session are updated and saved at the training program as the last saved thresholds limit.

### Advanced Calculations Method—Automatic Data Filtering Process

Stride Recognition

The software detects any increase or decrease of weight bearing from the hind foot or forefoot chambers above a fixed threshold as a start or end of a step, while any weight measurement below these thresholds defines as a noise and does not get into the calculation (FIG. 22). This step/stride recognition function is active in dynamic exercises (Walk Across and Stairs). This step recognition prevents from detecting any spike of weight bearing as a step which will affect the correct calculation of the average peaks of the entire steps and the number of steps.

Gait Cycle Calculation

The gait cycle begins with foot ground contact (Initial Contact) and ends with another ground contact of the same leg. Thus, each cycle begins at initial contact with a stance phase and proceeds through a swing phase until the cycle ends with the limb's next initial contact. As shown in FIG. 23, stance phase reflects the period of time when the foot is in contact with the ground and swing phase reflect the period of time when the foot is swinging forward.

Statistics Calculations

The SmartStep™ software uses advanced analysis of the force measurements in order to determine the patient profile. The analysis includes an automatic data filtering process that ignores irrelevant measurements from the entire exercise (for instance in walking—the sections where the patient start and finish the exercise are ignored leaving the middle section for results analysis). In this way, the final results on the software display are more accurate and the created training is more efficient. In addition, these automatic results simplify the use and the flow of the software.

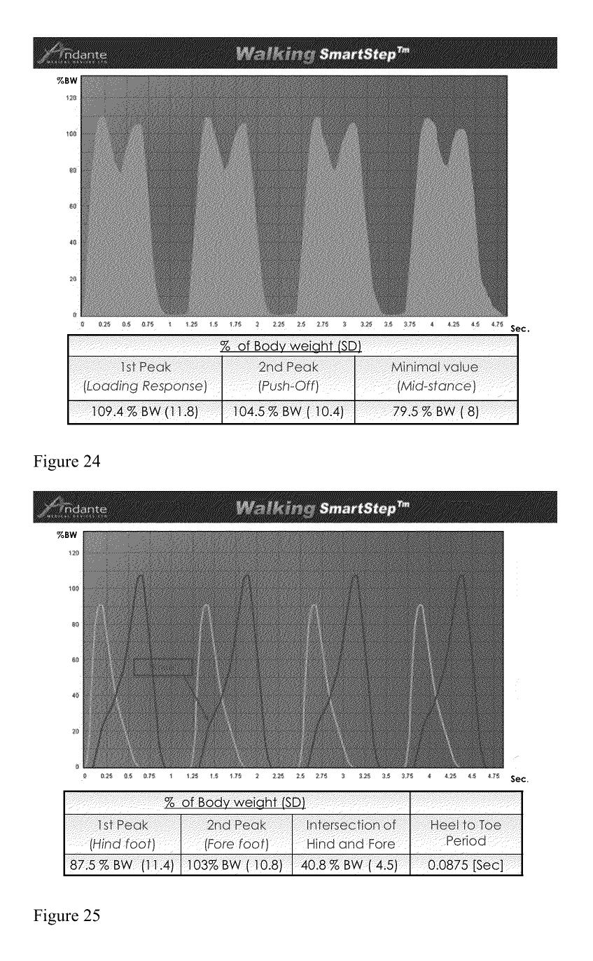

The software analyses the amount of weight bearing on the entire foot, hind foot and fore foot during dynamic activities (Walk Across and Stairs) and Static activities (STS, Standing, Weight Shift ML, and Weight Shift AP). Static measurements include average of weight bearing during the entire session (i.e. Standing). Post auto filtering the calculation will display the relevant range of measurement and the results will display the average and peak of weight bearing on the entire foot, hind foot and forefoot. Measured values for weight bearing throughout the patient's gait are illustrated in FIGS. 24 and 25.

Dynamic measurement includes detection of the peak value in each step and calculating an average of all peaks+Standard Deviation (STD) and detection of the value with reference to normal values (weight bearing on entire/hind foot/forefoot, temporal parameters−stance/swing and cycle time).

Several exercises in the SmartStep™ software use different approaches to calculation in order to determine what are the best weight bearing limits to be used for the training exercise. For instance, in the ‘Stairs’ exercise, the software analyzes the pattern of the graph and sets the required weight limits on different parts of the graph stage depending on whether it was during a ‘Step-Up’ or ‘Step-Down’ phase as there are different loading patterns in these two stages. In another exercise Sit-to-Stand (STS), the software analyzes the phase of a standing up to sitting down to determine the entire weight bearing. This procedure is done by calculating the major peaks of the standing up and sitting down points. The software filters any “noise” in the graph that might be wrongly determined as one of the required points. The software calculates the entire average weight between a ‘Standing up’ point to a ‘Sitting down’ point. For this analysis, the area is divided into three sections, and the peaks in the first and third sections are calculated and then the average is calculated.

Sit-to-Stand

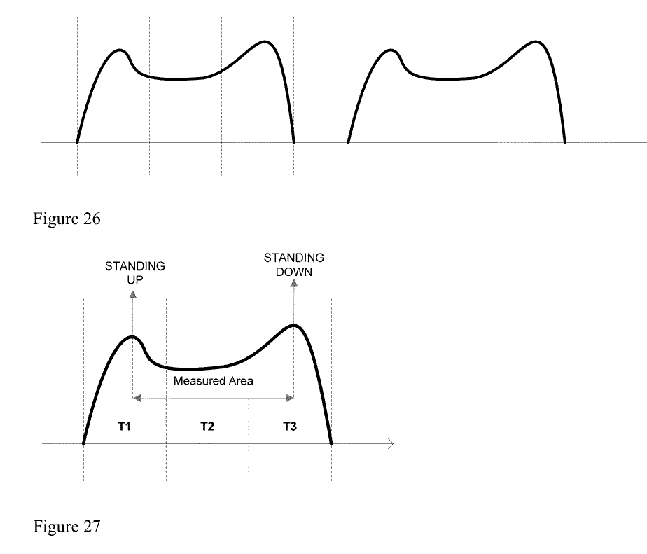

In sit-to-stand, the software conducts a specific analysis of the pattern in order to achieve an optimal measurement of this activity. STS includes movement and weight transfer from sitting position toward standing up, standing still, and sitting down. The graph of FIG. 26 shows a sample of a sit-to-stand pattern. As illustrated in the graph of FIG. 26, there is an increase in weight bearing during standing up and a decrease of weight bearing during sitting down.

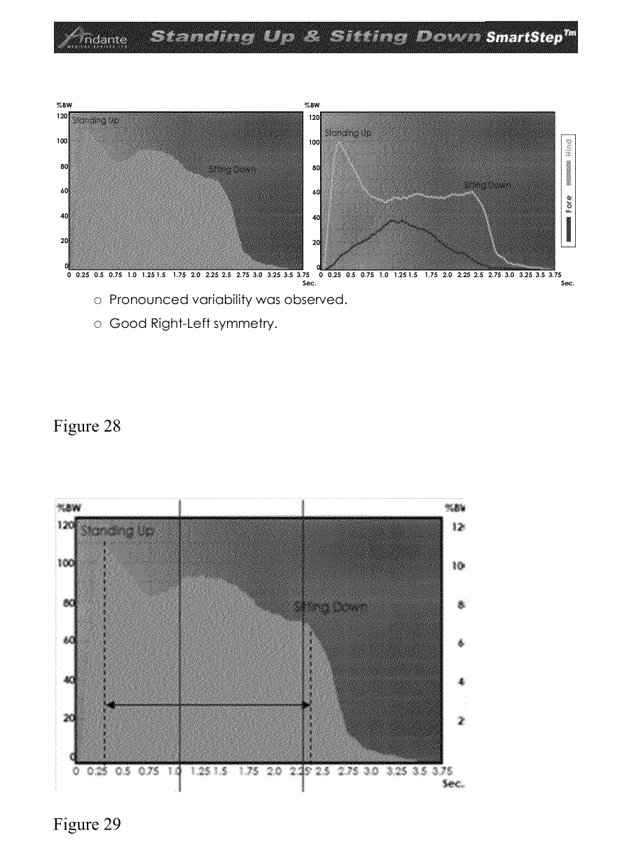

As the main area where the weight bearing should be calculated is between the standing up peak and the sitting down peak, the software performs a filtering on the graph, dividing the graph into three time frames and taking the first and last phases (T1, T3) while ignoring the middle sector (FIG. 27). The software detects the peak value in weight bearing (T1, T3) and sets each one as the stand up and sit down points, respectively. Then, the software measures the time duration for each point and the average weight bearing between these two points as shown in FIGS. 28 and 29.

Stairs Training—Up/Down

In normal conditions, during a stairs exercise the weight bearing is mainly on the forefoot. In stairs down and up, the main loading place is on the forefoot—during stairs down the forefoot decelerates and absorbs the body weight while in stairs up it pushes up the body to the next stair. On stairs down, there are two forefoot peaks, the first peak is higher than the second peak while in stairs up there are two peaks and the second peak is higher than the first peak. The software makes the analysis in order to determine the proper training limits.

Stairs Down

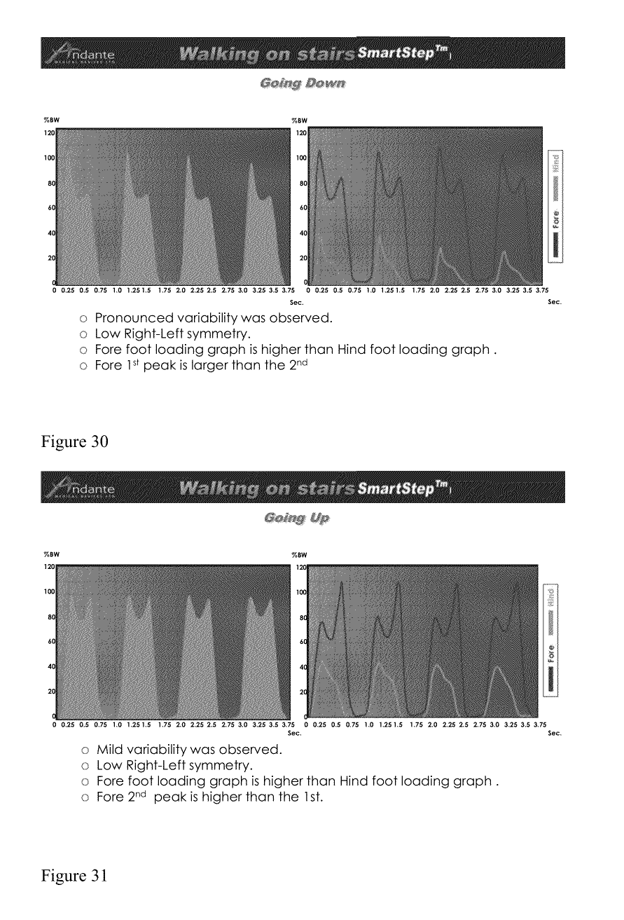

FIG. 30 illustrates the foot placement pattern during a stairs down exercise. The left graph shows the entire weight bearing over time—entire weight bearing is a sum of the weight bearing on the forefoot and hind foot. The right graph shows the fore foot and hind foot separately. As can be seen in FIG. 30, the first sector that comes into contact with the ground is the forefoot. The software takes each stair step and divides it into two phases, the first phase is counted as the stairs down and for this phase it finds the peak value. Even if the forefoot weight bearing might be higher on the last phase (not shown here) the software will ignore this phase and will only search for peak value on the first phase which is the relevant in the stairs down.

Stairs Up

FIG. 31 shows the foot placement pattern during a stairs up exercise. The left graph shows the entire weight bearing over time which is the sum of the forefoot and hind foot and the right graph shows the forefoot and hind foot separately. During climbing stairs up, the forefoot sector is in contact with the ground for the entire phase. The forefoot applies most of the weight at the second phase of loading (second peak) in order to shift the body toward the next stair. In order to train stairs up efficiently, the software ignores the first phase peak and searches for the peak on the last phase.

Auto Filtering

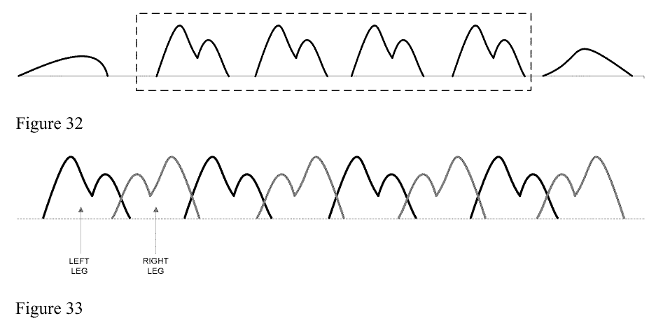

When starting an exercise, the software is logging the data in a record. When the exercise stops, the software displays the results in a graphical and numeric form with relevant statistics calculations. During an evaluation (L e., walking), there might be some period with different changing position (i.e., turning around, standing, etc.). In these cases, the weight bearing data are not relevant to the walking evaluation. As illustrated in FIG. 32, the software performs an auto zero selection to eliminate all the unwanted area and to remain with only the represented steps. In cases where irrelevant weight data are located between relevant data, the software compares the shape of steps and detects the irrelevant steps/turning measurement. The comparison between relevant and irrelevant data takes into account the weight bearing values and temporal data (stance/swing)

Bilateral Measurement and Feedback

In an exemplary embodiment, the software can synchronize, measure, and display bilateral activity using 2 control units, one on each ankle. During bilateral evaluation, the software analyzes the data from both legs and according to the clinical rules determines which leg requires feedback training: unilateral only or both. The use of bilateral operation allows the therapist to compare both sides in terms of weight bearing, foot placement, and stance/swing. As shown in FIG. 33, use of bilateral measurement also allows showing the graphs side by side (or one above the other) at the same chart. That way a visual comparison can be obtained.

The results from each control unit are downloaded and saved with a comment as to whether the data is for the left or right leg. According to the assessments results and clinical rules, a training program can be built for legs, left and right, with feedback location of entire/hind or fore.

Bilateral SET UP Option

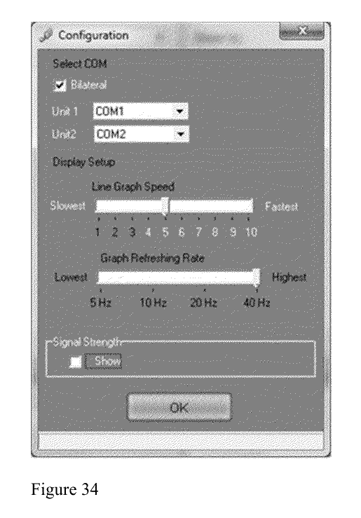

As illustrated in FIG. 34, setting the bilateral option is under the ‘Patient File’-‘Menu’-‘System Configuration’ of the user interface. Clicking the checkbox as ‘Bilateral’ enables both COM Ports. At the Patient File, the user clicks ‘Start Session’ to open the ‘Calibration’ screen for the two Legs. The bilateral session then proceeds as follows.

Inflating the Insoles in Both Legs:

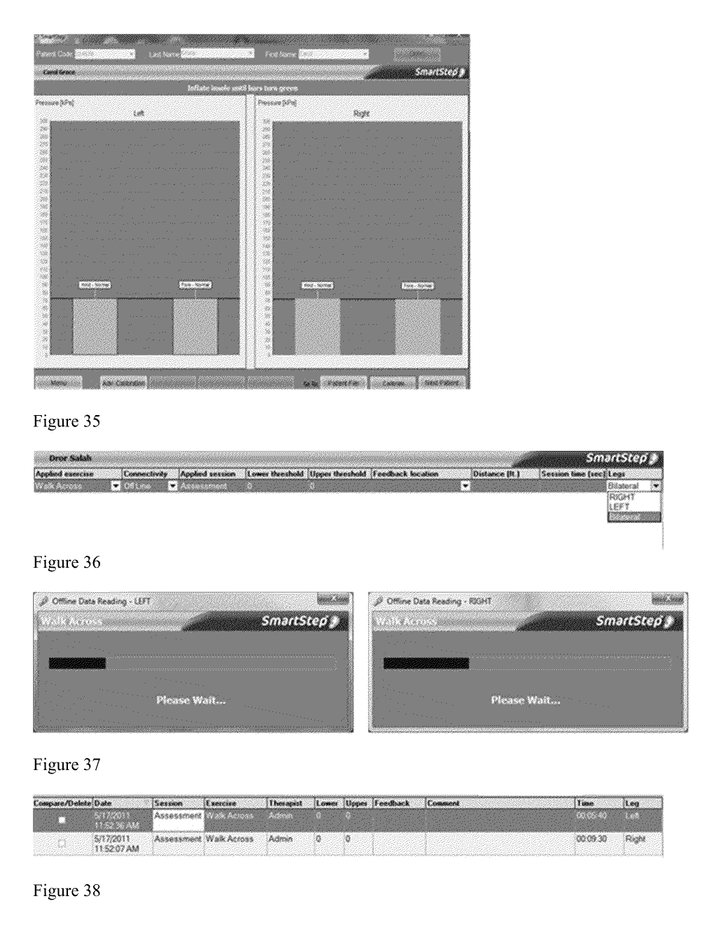

To inflate the insoles on both legs for taking measurements, the user takes the followings steps while viewing the display of FIG. 35:

1. Connect the air pump tube connector into one the metal tube sockets located on either side of the control unit.

2. Once the air pocket is inflated to the optimal pressure level, remove the air pump connector from the socket by pulling the grooved tube upwards.

3. Repeat the above process for the other socket, while the air pump is still on (if required, turn the air pump on again).

4. When finished re-inflating the hind and forefoot compartments, check the pressure reading. If pressure is now at the correct level (the bars are green), repeat the inflation process with the other leg. If pressure is now at the correct level at both legs (the bars are green), click Calibrate in the calibration screen (keep patient's leg at a steady state).

Once the air pockets are inflated, the user selects the desired exercise (i.e. Walk Across), Connectivity—only Offline. The user then selects the bilateral function at the ‘Legs’ button on the right end of the function bar as shown in FIG. 36.

Performing the Workout:

In the bilateral functionality, data logging is requiring from both legs as follows:

Starting the Session:

1. To collect session data on both legs, press and hold the operation button for 2 seconds on both control units. A dot is added in both control unit displays next to the mode number signifying that data collection is being performed and the unit beeps. FIG. 37 shows the resulting display.

2. To stop data collection, press the Operation button of both control units once. The dot disappears from the control unit display.

Downloading Session Data to the Computer:

1. In the offline data reading dialog, click Download software to download the data from both units, one at a time.

2. Two file records are created at the previous session, one for the left leg and one for the right leg, as shown in FIG. 38.

3. When the data has finished downloading, the results screen for the last control unit exercise opens.

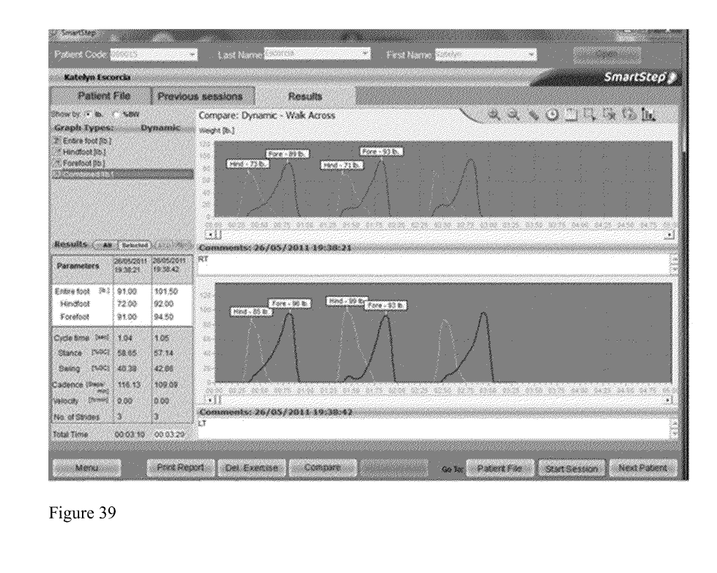

A bilateral report display for graph and numeric results is illustrated in FIG. 39.

Inflation Unit

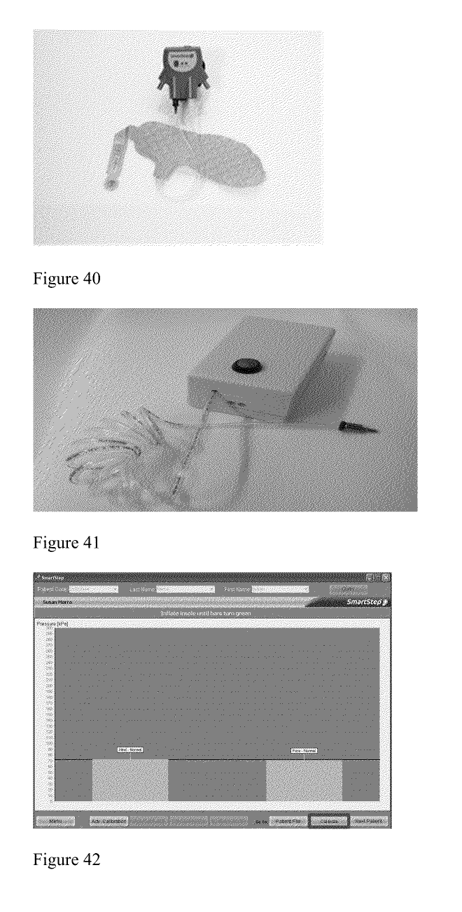

The insole and control unit are illustrated in FIG. 40. In an exemplary embodiment, the control unit includes a metal panel mount for inflation with one hand. Inflation using only one hand is desired since many individuals using the devices of the invention may have had a stroke and have limited abilities on one side of the body. However, the system may also include an electrical pump as illustrated in FIG. 41 that provides automatic inflation to accurately and automatically inflate the insole using one hand only to a specific pre-defined pressure level which is used for normal operation. The electrical pump may use a built-in pressure sensor to monitor the amount of pressure and with use of an on board controller the pump stops inflation at the required pressure level. The electrical pump includes an adjustable mode so each pump can be easily calibrated. The electrical pump enables inflation of the air insole with one hand through a panel mounted metal valve at the control unit.

The inflation pump is used to inflate the insole to the initial fixed pressure level. Inflation of the insole can be done with a manual pump; however, manual pumping requires the user to observe the pressure levels on the display. The inflation pump unit of FIG. 41 is a self-monitored automatic pump, which integrates an accurate pressure sensor that detects the current pressure of the insole stops the inflation when the detected pressure reaches the predefined level.

An air pump is used to inflate the insole as follows:

1. Turn on the air pump and insert the air pump tube connector into one of the metal tube sockets located on either side of the control unit.

2. Once the air pocket is inflated to the optimal pressure level, remove the air pump connector from the socket by pulling the grooved tube upwards.

3. Repeat the above process for the other socket, while the air pump is still on (if required, turn the air pump on again).

4. When finished re-inflating the hind foot and forefoot compartments, check the pressure reading. If pressure is now at the correct level (the bars are green), click Calibrate in the calibration screen (keep patient's leg at a steady state). FIG. 42 shows the display during inflation and the visible threshold that advises the user when the inflation is completed.

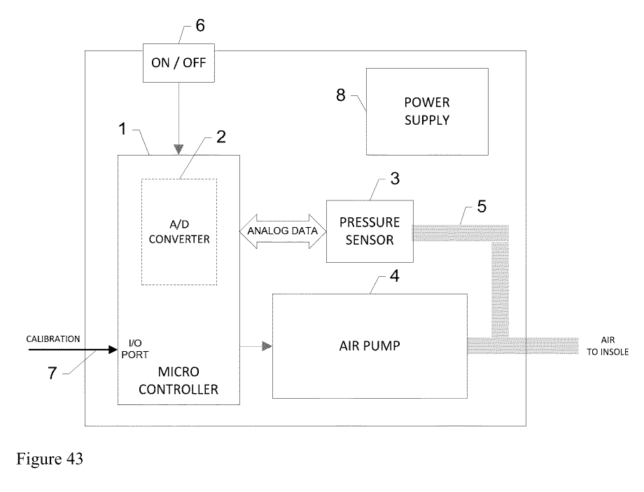

FIG. 43 illustrates a basic block diagram of the inflation pump. As illustrated in FIG. 43, the inflation pump unit includes an electrical air pump (4) that has a maximum pressure level that is more than the level required to inflate the insole. The air pump (4) output is provided to an air tube (5) which is used by the user to connect to the insole. The air also flows to the mechanical input of pressure sensor (3). The pressure sensor (3) output is analog data (DC voltage) that represents the pressure level. This output is connected the microcontroller (1) component at the A/D converter (2). The A/D converter (2) converts the analog pressure level to digital values in resolution of 10 bit (1024 discrete levels) for further analysis by the microcontroller (1). The microcontroller (1) samples the pressure data at a 100 Hz rate that is found to be sufficient for detecting the required pressure while the air inflation (4) is continuously operating. As the microcontroller (1) detects the required pressure level it sends a control line signal that stops the operation of the air pump (4). On/Off push button (6) is used for triggering the operation of the inflation pump. When clicked, the microcontroller (1) sends a control line signal that starts the operation of the air pump (4). The inflation pump includes an internal switch that when pressed causes the microcontroller (1) goes into calibration (7) mode. This is used for calibrating the fixed predefined pressure level to compensate for components deviation and when a different pressure level is required. As long as the calibration switch is pressed, the microcontroller (1) monitors the pressure to be set as a new level. At this point, the user presses the ON/Off button (6) to start the air pump. The pump in the calibration mode works only when the ON/OFF button (6) is continuously pressed, so that the user makes pulse presses on the ON/OFF button (6) and increases pressure. When it reaches the new desirable level, the calibration switch can be released and a new level will be set at the microcontroller (1) internal memory.

The inflation pump is powered by internal power supply (8) unit (rechargeable battery). The power supply (8) is connected to the inflation pump internal components—microcontroller (1), pressure sensor (3) and the air pump (4).

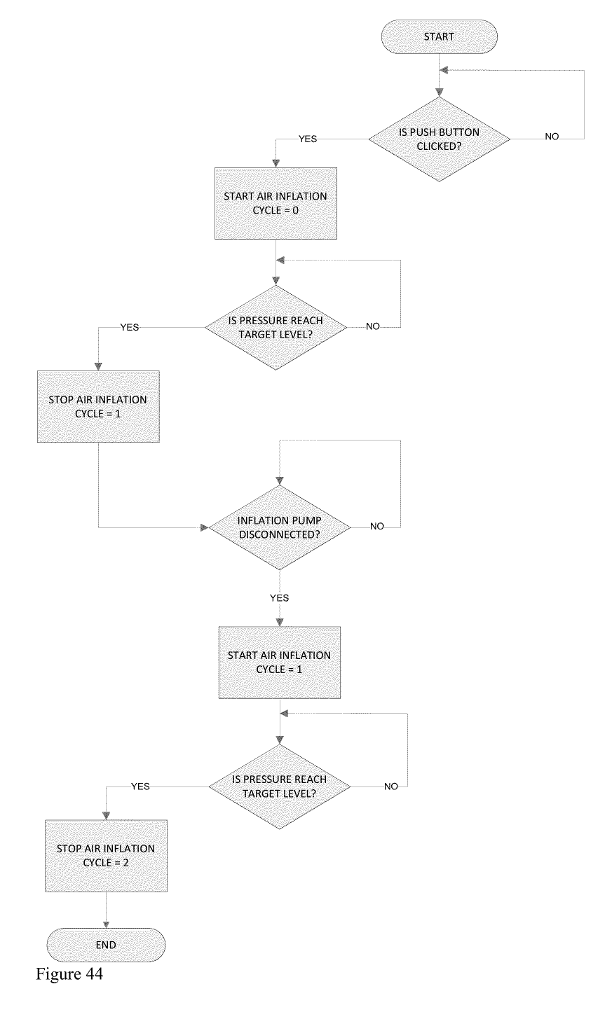

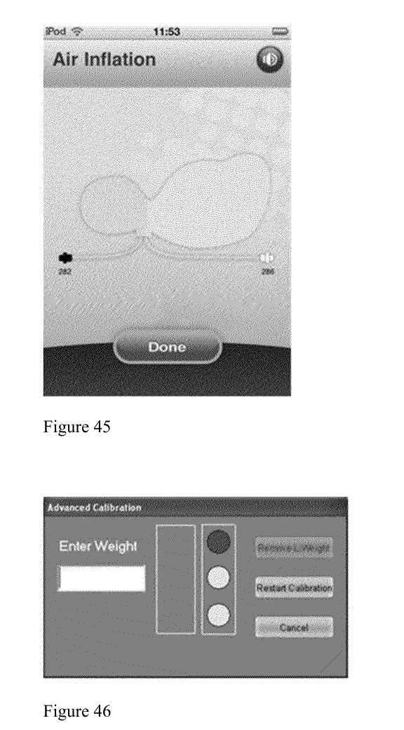

FIG. 44 illustrates the flow chart of operation of the inflation pump. As illustrated, the microcontroller (1) detects if the ON/Off push button (6) is pressed. If it was pressed, it starts the air pump (4) operation. The air pump pushes air to the insole and when the microcontroller (1) detects the target pressure it stops the air pump operation. At this point, as long as the inflation pump tube connector is connected to the insole, the air pump (4) is not working. The microcontroller (1) sets the variable cycle to be 1, meaning the first insole sector (Hind/Fore) is completed. When the user disconnects the tube pressure drop and the microcontroller (1) detects it, the air pump (4) operation is started again in order to inflate the second insole sector. As the user connects the air tube to the second insole sector and the pressure increases, the microcontroller (1) monitors the pressure until it reaches the desired pressure level. When the pressure reaches the target, the microcontroller (1) stops the entire operation of the air pump (2 cycles were completed). FIG. 45 illustrates a sample display during inflation.

Post insole inflation within the inflation range, the software counts the inflation level as a new zero level, and the software normalizes the absolute pressure inside the insole. Any pressure above this normalized value is considered as a weight bearing. During a session, the air pressure can decrease. As the software monitors the absolute pressure level when there is a decrease in pressure and the pressure level reaches a low threshold, the system alerts the user that the pressure has decreased. In this situation, normally the user should hold and re-inflate the insole again.

As long as absolute pressure levels are still in the inflation range, the auto zeroing function performs an automatic normalization of the pressure when it drops. This method allows smooth operation and elimination of the need to re-inflate (recalibrate) the insole. As the software makes the auto zeroing function, a new zero level is set. When pressure drops below the minimal inflation range, the software does not perform any more zeroing. At this point, the software will generate indication of an air pressure alert.

Calibration: Advance Calibration Static Mode and Dynamic Mode

The software measures the amount of pressure applied on the insole using a look-up table that converts each pressure value to a force reading value. The procedure of building the conversion table is called ‘Calibration.’ The first stage in the calibration process is to select the appropriate pressure sensor that allows reaching the maximum required force measurement and yet be sensitive enough to get a good resolution in force increments. The second stage is to define the specific amount of air (initial pressure) that the insole is filled with so that there will be enough pressure to handle the maximum required force measurement so the insole will not reach its saturation (Point-to-Point level) and the pressure sensor will also not reach the saturation level and will be able to measure up to the maximum required force. Once the pressure sensor and the inflation level are set, the next step in the process is to take measurements from several subjects. The measurements are done in such way that each subject wears the insole and applies weight on a digital scale. For an increment of 5/10 Kg the tester takes the relevant pressure value for each weight. At the end a linear curve is built (look-up table). This process is done for all the subjects and all subjects' linear curves are gathered together for analyzing. At the end, a single curve is built that represents the entire results from all the tested subjects. More details regarding the calibration process may be found in U.S. patent Ser. No. 11/910,699, the contents of which are incorporated herein by reference.

The calibration process is done for each side of the insole Hind/Fore and for all available insole sizes. The calibration process is divided for static and dynamic exercises. In static exercises, the measurements are taken as the entire foot is placed on the digital scale, while in dynamic exercises, analysis of the subject gait pattern is taken into account whereby the force is applied only on part of the insole that is in contact with the ground while the foot is angled during the heel strike and the push off gait stages.

To validate the first created linear curve, a set of tests are performed on additional subjects. Analysis of the data is done and, if required, changes are made to the conversion table. The process is then repeated until results are within the predefined deviation definition.

Advanced Calibration

In certain cases, such as when patients use prosthetics or splints, have high or low arches, or other factors, the pressure conditions inside the shoe can deviate from the norm. This can cause a deviation in the results. In these cases, the user may need to perform an advanced calibration for that specific patient. The advanced calibration can be performed only after the general calibration has been completed. The advanced calibration allows the user to check and adapt weight readings against readings on a normal scale.

Advanced calibration in accordance with exemplary embodiments of the invention includes the steps of:

1. In the inflation screen of FIG. 42, click Advanced Calibration. The dialog box of FIG. 46 opens.

2. Enter a specified weight, for example 20 kg/44 lb., in the enter weight field. 3 kg/6.6 lb. is the minimum weight allowed.

3. Instruct the patient to place his foot on the scale and to exert enough pressure to reach and to maintain the value entered.

4. Once the scale reads and maintains the specified weight, press enter.

5. Repeat steps 2-4, each time increasing the weight by at least 3 kg/6.6 lb. At least 3 readings must be entered to complete advanced calibration (i.e., the user may use 10 kg/22 lb, 20 kg/44 lb and 30 kg/66 lb, or 20 kg/44 lb, 30 kg/66 lb, and 40 kg/88 lb or even 50 kg while the patient is near a bar/chair support). When a green icon appears in the advanced calibration dialog box (FIG. 47), the device has been successfully calibrated for this specific patient.

6. If calibration is still unsuccessful, more weight readings are entered until the calibration is successful.

7. After completing advanced calibration, click Start Exercise to activate advanced calibration and to proceed to the workout plan design screen.

When advanced calibration has been performed, and is active, a label indicating it is active appears in the upper right of the Patient file. Advanced calibration is canceled when a new patient is added or chosen. To reactivate it, the process is repeated (steps 1-7).

While the subject applies weight on an external accurate and calibrated scale, the software compares the built-in linear tables with the values from the reference digital scale that are entered in the software by the user. As long as the result of comparison shows high linear correlation between the two measurements (general conversion table, external digital scale) the software applies the new linear equation on the base built-in table. In a special case of the advanced calibration, the two measurements devices are both connected to the software which samples and synchronizes both signals in real-time. As a result, the comparison in this case is much more accurate and delivers higher results.

The software uses several sampling methods. In one mode, as the patient stands on the scale, the user taps on the software at a desired weight value. At this point, the software samples the two signals and stores them. This process is done at least three times for the linear comparison to be more reliable. At the end of this procedure, the software calculates the correlation and updates the built-it look-up table by the linear correlation equation.

In another calibration method in accordance with methods of the invention, as the patient stands on the scale, the software continuously samples the data from both signals, so multiple points are taken into the calculation. The patient can apply several weights on the scale. At the end of this process, the software again checks the correlation and applies a new linear equation on the base built-in look-up table. While the previous mentioned methods are used for fixing static exercises, this method of correction is done for dynamic exercises, especially for walking. In this method, the patient walks on the scale as the software samples the data from the system and the digital scale continuously. This procedure is done several times where at the end the software again checks the correlation of the data. In this case, the software analyzes the walking pattern from both signals. This specific case of automatic calibration can be used as a general routine before working with the system so the patient applies weight on the digital scale where data from the scale and the system are sampled so a personal linear curve is built. This can be done for static and dynamic exercises, and it is unique for this patient. The personal table can be saved under this patient ID for later uses.

Transferring the Patient's Personalized Training Program from a PC to a Portable Electronic Device (e.g. iPod/iPhone/iPad)

Individuals discharged from rehabilitation following stroke are, in many instances, left with significant disabilities. The limited availability of ongoing exercise programs to maintain and/or improve functional ability is a major oversight in stroke management. Without such ongoing and “top up” exercise programs, rehabilitation gains can be lost once individuals are free of the structure of the rehabilitation setting. Basic functional performance such as standing up and step up are critical to an independent lifestyle. Difficulties performing these skills may impose continuing physical inactivity and social isolation on disabled individuals. STS and Step-Ups (described above) are both weight bearing actions that involve the production of lower limb extensor forces across three lower limb joints with the feet fixed. The stance phase of walking also involves the lower limb kinetic chain and increased strength in extensor muscle is linked to increase in speed of walking. Transfer across actions with similar dynamics is preserved in patients with stroke-related brain damage.

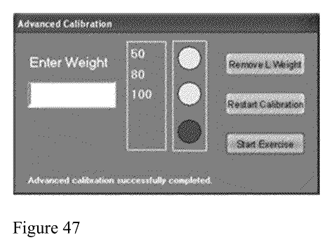

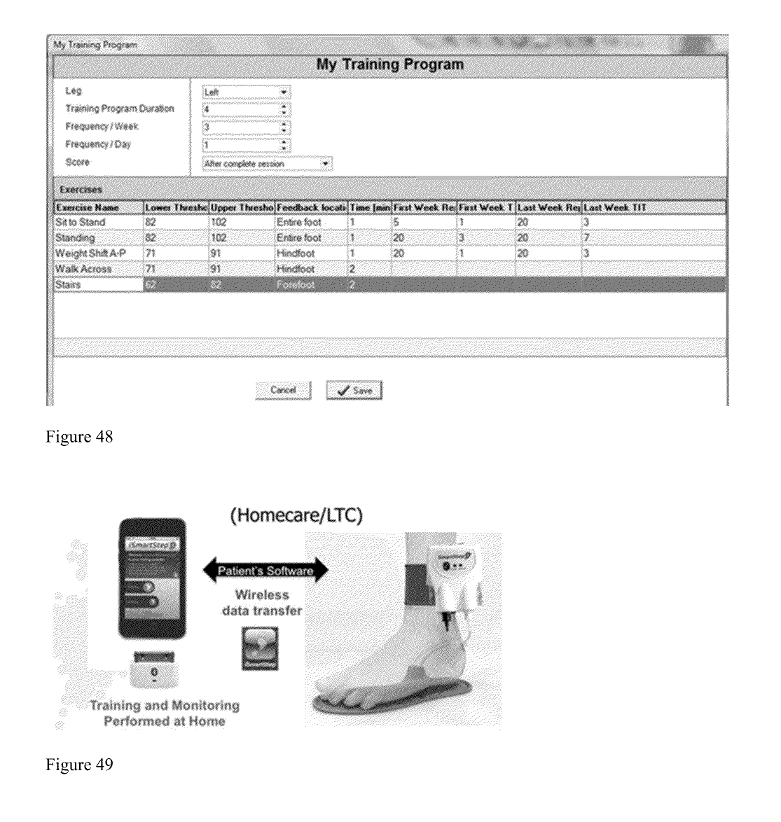

As described above, the brain retraining system of the invention permits the clinician to assess the patient's ambulatory and or functional performance and then to prescribe an appropriate objective therapy regimen for the patient that efficiently drives the rehabilitation process toward safe and independent walking capabilities. FIG. 48 illustrates a patient's sample personalized training program screen developed using the software described above. This section will explain how the illustrated training program is transferred from the therapist's PC, handheld computer, smart phone or other processing device to a portable electronic device to facilitate the patient's home therapy.

In an exemplary embodiment, the patient's personal training program is transferred from the therapist's processing device running the PC software through a server that stores the therapist's data for multiple patients or directly to the patient's mobile device. In an exemplary embodiment, the patient's mobile device is a smart phone or other handheld processing device such as the iPod/iPhone/iPad family of products available from Apple, Inc. Preferably, the handheld device allows for wireless communications with the control unit or is adapted to include a Bluetooth™ SPP transceiver adapted, in the case of Apple products, for use with the iOS App. A Bluetooth™ enabled iPod Touch device with a Bluetooth™ SPP transceiver adapter is illustrated in FIG. 49 for use with the system illustrated in FIG. 6 and described in detail above. The Bluetooth™ SPP transceiver adapter includes an authentication chip and is plugged into the connection socket of the iPad/iPhone/iPod for authentication of the Bluetooth™ SPP transceiver. Once authenticated, the Bluetooth™ SPP transceiver enables operation with the iOS App of the iPod Touch and enables wireless transfer of raw data from the iOS App to a Bluetooth™ enabled device, such as the connection unit illustrated in FIG. 49 and described above. Of course, those skilled in the art will appreciate that other wireless transmission configurations may also be used. Once his/her handheld device is Bluetooth™ enabled, the patient starts his/her training program using displays presented on the mobile iPod/iPhone/iPad display and/or verbal instruction and/or audio feedback and/or vibration from the iPod/iPhone/iPad display.

The handheld device described below may be implemented in a clinic mode to replace the PC embodiment used in the therapist's office as described above as an assessment and re-training tool. In this mode, the handheld device includes applications that permit the therapist to perform gait and functional assessment and training of the patients. The applications loaded on the device also manage the patients' data and permits synchronization of the patients' data with the server holding the patients' data for all patients of the therapist.

The handheld device described below also may be implemented in a patient mode and includes the patient's training program as defined by the therapist. The patient has no access to the training program, but the therapist may switch the device to the clinic mode to permit modifications to the training program by the therapist.

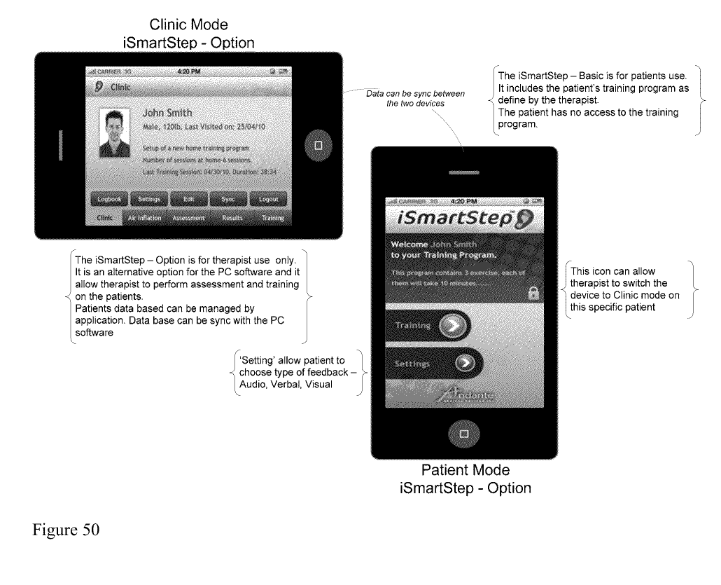

FIG. 50 illustrates display screens for the handheld device in the clinic and patient modes.

As in the embodiment described above, the handheld device in a clinical mode detects patient capabilities in low and high levels of Activities of Daily living (ADL): Sit to Stand (STS), standing, walking, and stairs. The system detects the weight shift loading pattern in STS (heel to toe movement), total loading of the affected side in standing (location of weight bearing—backward or forward), and total loading on the affected leg. The system detects the patient's gait pattern and deviations in different pathologies.

Then, as in the above embodiment, in clinical mode, the software automatically builds a functional training program according to the patient's gait deviation or capabilities in ADL. The functional training program parameters (e.g., repetition, time, time in the target, etc.) during the training period at home may be modified through wireless access to a secured server or a direct synchronization between the patient's handheld device and the therapist's device. Such synchronization may be between two handheld devices or between a handheld device and a PC. As in the above embodiment, the software loaded into the handheld device may have a built-in “clinical rules algorithms” for building a training program in the clinical mode based on the evaluation outcome in all the functional activities (static and dynamic). Based on the clinical rules algorithm, the software automatically sets a training program that includes the specific exercises with the calculated feedback thresholds (lower and upper) that refers to patient body weight and feedback location as described in the above examples.

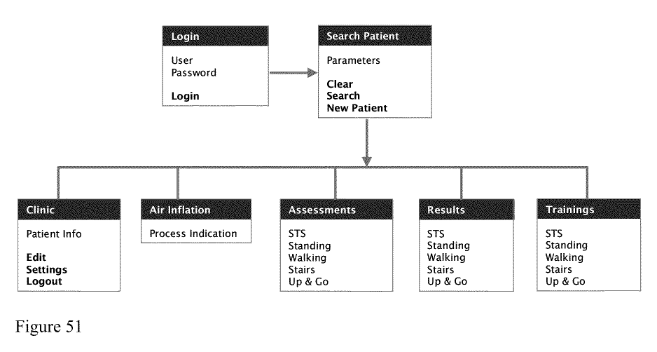

In the clinic mode, the clinician starts by selecting the Assessment tab of the display to begin an assessment of the patient's functional ability. The software builds a training program according to the patient objective outcomes (Results tab) that is based on the clinical rules described above. The training program (Training tab) can be performed at the clinic using the display of the clinician's handheld device or on the patient's handheld display once it has been synchronized to the clinician's handheld device whereby the clinician can see if the training is suitable for the patient. As shown in FIG. 51, once the login process is completed and the device is ready for new patient data, application tabs are presented including:

‘Clinic’ tab—handling the patient file;

‘Air Inflation’ tab—set up air inflation level;

‘Assessments’ and ‘Training’—main functional tabs; and

‘Results’ tab—patient evaluation data.

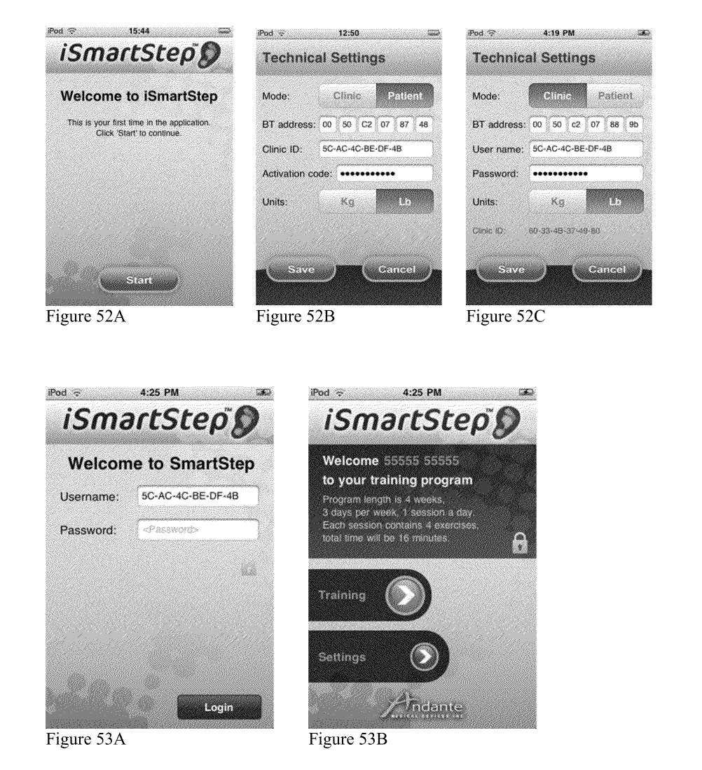

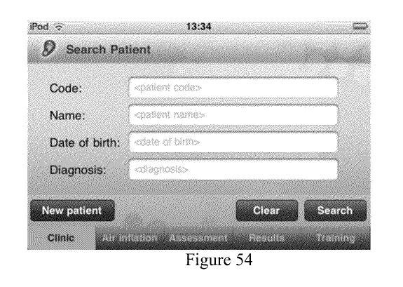

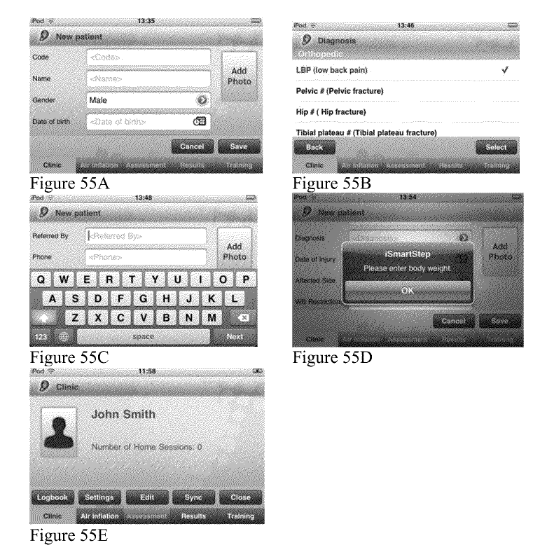

FIG. 52 illustrates an exemplary flow of operation and exemplary displays during setup of the handheld device upon selection of the ‘Clinic’ tab by the clinician. As illustrated in FIG. 52A, if this is the first time the clinician has accessed the system, the device presents a welcome screen and then enables the clinician to enter initial patient information in the display of FIG. 52B and initial clinician information in the display of FIG. 52C. If the user has previously used the system and is set up with a user name and password, the clinician and/or patient may be presented with the displays of FIGS. 53A and 53B. The clinician may then be presented with a display such as that of FIG. 54 in order to search for patient data. The clinician provides information about the patient that is solicited by the display screens of FIGS. 55A-55D until the patient is found (FIG. 55E). Patient data may also be uploaded from the server database as appropriate.

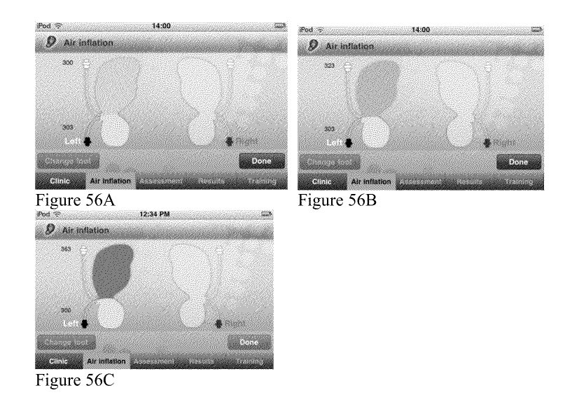

Once the patient has been found, or setup, in the system, the assessment device (FIG. 6) is set up for the patient. As noted above, the first step is to inflate the insole. This is facilitated by selecting the ‘Air Inflation’ tab of the handheld display, and upon selection the clinician is presented with the display of FIG. 56 to track the inflation of the left, right, or both insoles to the desired pressures. The inflated insole(s) is/are placed in the patient's shoe(s) and the control unit is turned on and prepared for gait and functional assessment as described above.

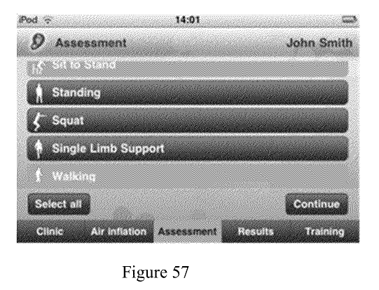

FIG. 57 illustrates a list of the therapy assessments that the clinician may select. The assessments of the patient ambulatory of functional performance include, inter alia, Sit to Stand (STS), standing, squat, single limb support, walking, stairs, etc.

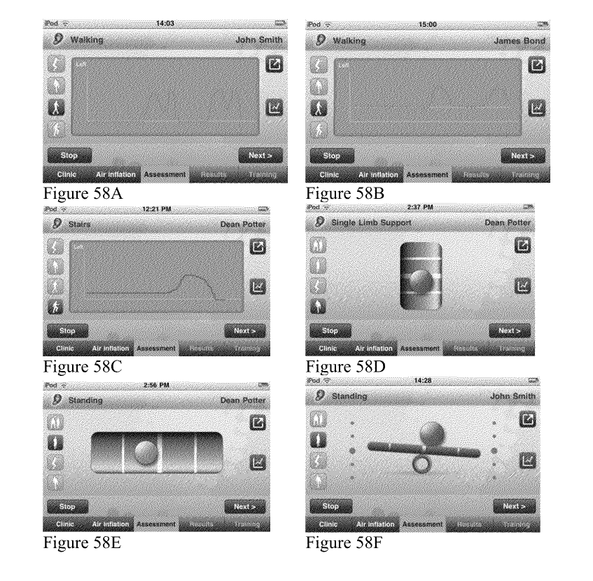

FIGS. 58A-58F illustrate exemplary displays during an initial online assessment of the patient while walking (FIGS. 58A-58B), climbing stairs (FIG. 58C), single limb support (FIG. 58D), and standing (FIGS. 58E-58F). It is noted that display elements such as balls are used to represent the patient's weight loading and balance in a graphical, user-friendly way. Operational flow in a single exercise is described below. Multi-exercise flow assessments are performed one after the other according to the sequence list of the selected evaluation.

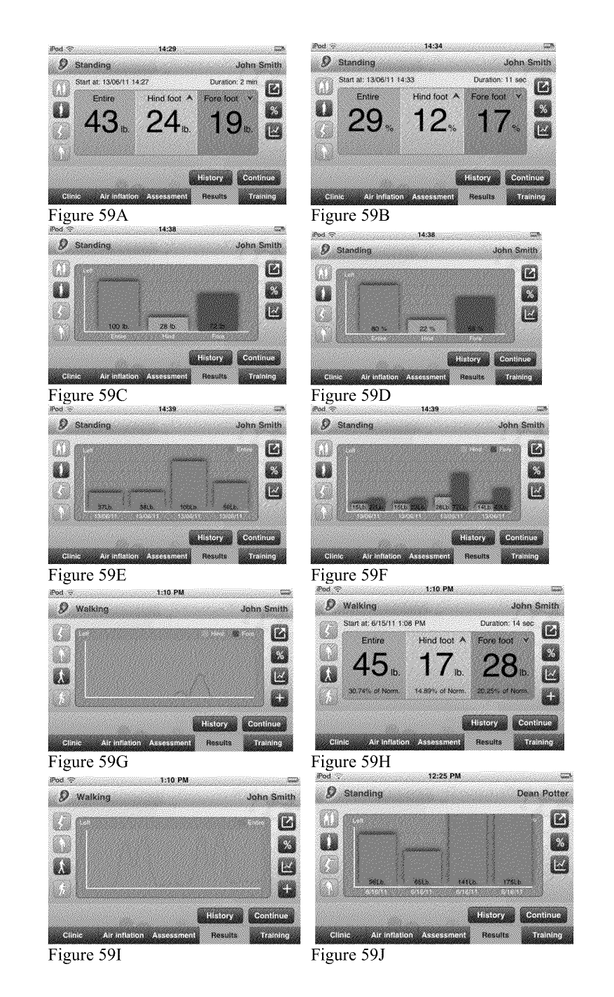

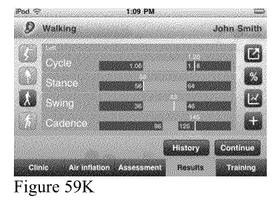

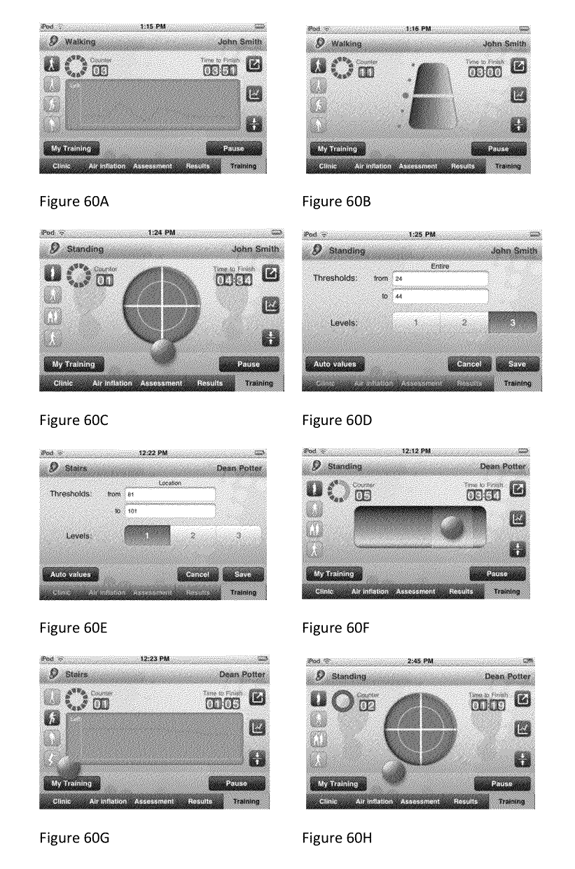

FIGS. 59A-59K illustrate results/trends in the initial assessment of the patient where FIGS. 59A-59F illustrate the results of a standing assessment and FIGS. 59G-59K illustrate the results of a walking assessment.

FIGS. 60A-60K illustrate respective training displays that the user may use during implementation of the selected therapies, where FIGS. 60A-60B show training displays during walking, FIGS. 60C, 60D, 60F, and 60H show training displays during standing, FIGS. 60E and 60G show training displays while performing a stairs assessment, FIGS. 60I and 60J show training displays during weight shift AP, and FIG. 60K illustrates a sample display encouraging the patient to continue during a Sit to Stand exercise.

Generally speaking, such visual displays provide at least the following advantageous features:
1. Ability to give feedback for heel and toes simultaneously (same beeps for both and or 2 different signals and or verbal instruction);
2. Add a normal value at the lower graphs for superposition with a different color; and
3. Active compliance assessment (verify retention with no feedback).
   Transfer of the “Training Program” from the Clinic Software to the Handheld Device

As described above, the clinical system (software at the clinical setting) detects gait deviation and patient functional ability in task-specific (sit to stand, standing, step up, etc.) assessments and, based on clinical rules, builds a training program including a clinical and home based protocol that includes a number of specific functional exercises with the specific thresholds, feedback location, time/repetition, time in the target that is sent to the patient handheld computing device (e.g., iPod Touch/iPhone/iPad) through server network communications. The training program may also be updated through the server periodically by pushing data to the handheld device or the data may be updated through auto synchronization. The updates are generally based on patient performance compliance and or/progress reports that are sent back to the clinics at the end of each exercise, at the end of the entire daily session (that included a few exercises), or at some other designated times. The training program along with the training parameters (e.g., force thresholds, time/repetition, time in the target, etc.) preferably include identification parameters that may be used for security purposes and to ensure that the correct training program is sent to the correct patient. The relevant identification (e.g., clinic ID number, PC computer number, and the personal insole ID) are unique values that are entered at the patient's technical setting (FIG. 52). The handheld device listens to the remote server and recognizes if the training program or an update thereof is available.

### Auto Update of Training Program Based on Patient Compliance/Progress

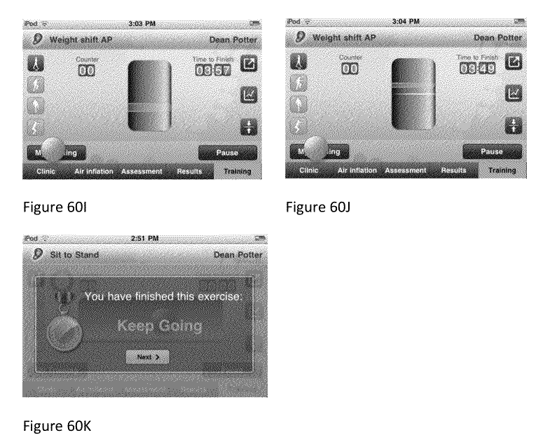

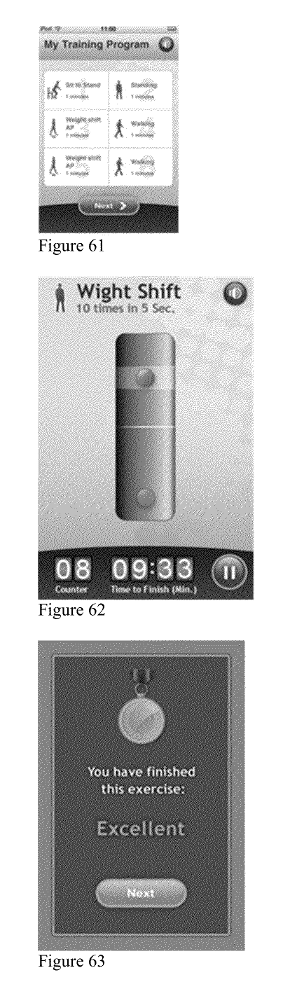

Updating of the training program may be conducted manually by the clinician at the clinic. In this case, the patient's handheld device can be programmed to send a notification note on patient compliance and/or progress on a defined timeframe or as a request from the clinician in order to make a decision about modification of the current training program. On the other hand, an automatic protocol may be set during the entire range of training with a gradual modification of the personalized training parameters (Time (T), Repetition (R), Time in the Target (TIT) according to the patient level (Level 1 to 3), as illustrated in FIG. 61 and set forth in the example table below:

| | Level 1 | | Level 2 | |
|---|---|---|---|---|
| | First Week | Last Week | First Week | Last Week |
| Training Exercise | T \| R \| TT | T \| R \| TT | T \| R \| TT | T \| R \| TT |
| Standing | 2 \| 10 \| 2 | 2 \| 10 \| 5 | 4 \| 20 \| 3 | 4 \| 20 \| 6 |
| Walking* | 2 | 3 | 4 | 5 |
| Sit-to-Stand | 1 \| 3 \| 6 | 2 \| 6 \| 6 | 2 \| 6 \| 4 | 3 \| 9 \| 4 |
| Weight Shift ML | 2 \| 10 \| 2 | 2 \| 10 \| 5 | 4 \| 20 \| 3 | 4 \| 20 \| 6 |
| Weight Shift AP | 2 \| 10 \| 1 | 2 \| 10 \| 2 | 4 \| 20 \| 2 | 4 \| 20 \| 3 |
| Stairs* | 2 | 2 | 3 | 3 |

The training program may also be updated automatically based on updated clinic decision rules based on patient compliance/adherence to the training exercise and progress at ambulatory and/or functional performance. In this mode, the software recognizes the patient's level of performance/compliance/progress and modifies the training program accordingly to adapt the patient's capabilities. For example, when the patient completes the training program successfully, the application will automatically update the training program and increase the difficulty level or reduce the difficulty level when the patient does not successfully complete the training program. Any such change in the training program parameters will cause a note to be generated and sent to the therapist. In the special case of a Partial Weight Bearing (PWB)/Toe Touch (TT) training program, the force thresholds are monitored carefully and the handheld sends a notification remarks to the therapist and the orthopedic surgeon about any PWB threshold modifications. In this fashion, the clinician may monitor patient performance, progress, and/or compliance and/or adherence to therapy and according to the patient's outcomes/results/compliance the software and/or the clinician may automatically or manually modify the training program according to the dynamic changes from moment to moment in the home environment, and without a visit to the therapist.

### Re-Training Feedback Methods

In the patient mode, the handheld device presents exercise options (FIG. 57) for the patient's selection and then guides the patient through the exercises with appropriate feedback for re-training the patient to proper compliance with the training regimen. A first type of re-training feedback includes concurrent, post response feedback including knowledge of results, with combined modalities. FIG. 62 illustrates visual feedback on the patient's weight shift therapy, while FIG. 63 illustrates post-performance positive reinforcement visual feedback.

A second type of feedback includes feedback on different aspects of gait/functions including, for example:

Loading parameters,

Gait Phases—Stance/Swing, Heel to Toe Period,

Cadence,

Freezing time (Parkinson)

Prosthetic Realignment

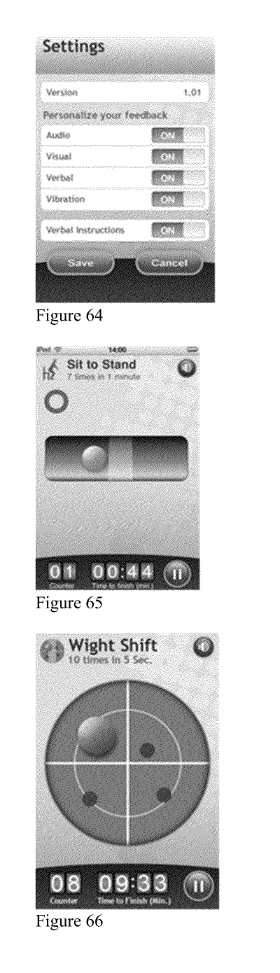

Bilateral feedback includes a symmetry index to prevent overload on the sound limb and to correct gait patterns in bilateral populations (MS, CP). As illustrated in FIG. 64, the user may select feedback modalities including visual, audio, verbal, vibration, or a combination thereof.

Feedback applications during use of the invention may include at least the following:

STS—Feedback for biomechanical pattern (backward to forward) and/or entire weight shift to the affected leg (combining visual and/or auditory and/or verbal feedback). A sample visual feedback display for STS is illustrated in FIG. 65.

Standing—Feedback for loading pattern (Backward vs. forward) and/or entire weight shift to the affected side (combine visual and/or auditory and/or verbal feedback).

Weight Shift—Sample visual feedback for weight shift is illustrated in FIG. 66.

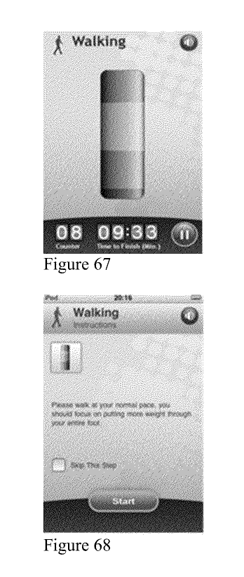

Walking—Feedback for loading pattern (heel and/or forefoot, heel and forefoot with 2 different signals at one step or entire loading to facilitate weight shift. A sample visual feedback display for walking is illustrated in FIG. 67.

Stairs—Feedback for a loading pattern (forefoot) or entire foot may include any of the feedback modalities.

Verbal Feedback

Verbal feedback may also be provided in the form of voiced instructions provided by the audio circuitry of the mobile computing device (e.g., iPod/iPhone/iPad). The verbal feedback may also be simultaneously displayed as visual feedback as shown in FIG. 68. Verbal feedback guides the patient during the training session through positive feedback (e.g., ‘Good’, ‘Nice Job’ etc.), or encouraging feedback according to the performance (e.g., ‘try again’ when the patient did not arrive at the goal, or ‘more weight’ when the patient is close to the goal). The verbal feedback frequency can be configured or fine-tuned by the clinician by, for example, increasing or decreasing the number of ‘Positive’ or ‘encouraging’ cues to fit the patient and to encourage a positive experience with the feedback.

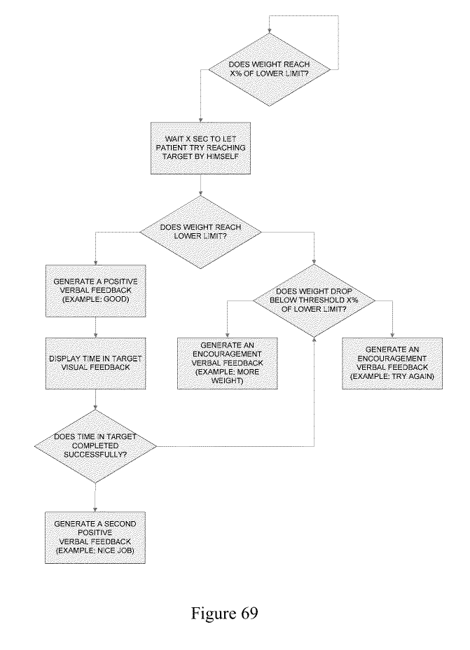

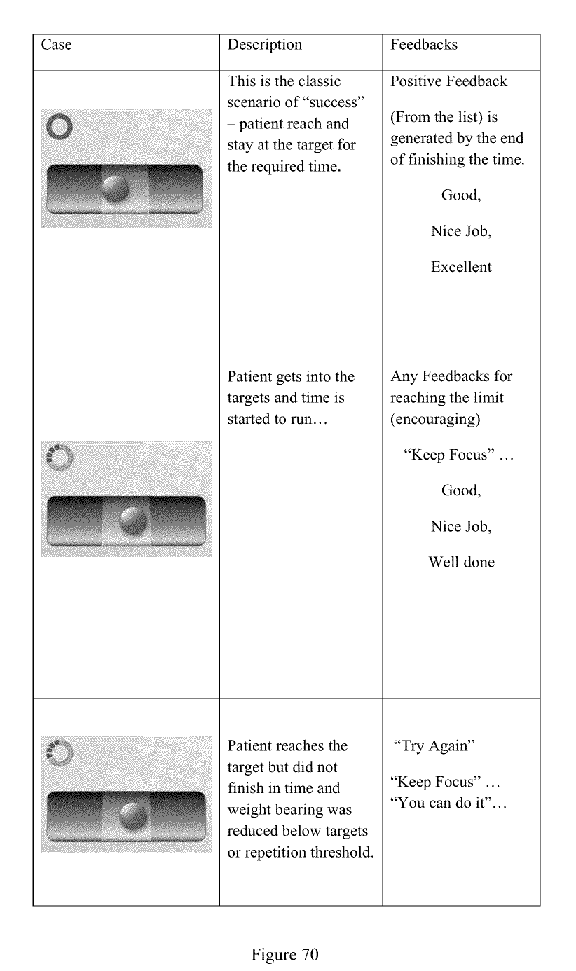

In exemplary embodiments, a positive feedback is generated when the patient reaches a goal. For example, as shown in FIG. 69, if the patient reaches the lower limit threshold and stays in the target for a defined number of seconds, encouraging feedback is provided. Conversely, when the patient is below the lower threshold by X %, the software may recognize that and apply an internal timer to check if the patient can reach the lower target. If the time has passed and the patient is still below the target range, the software may generate an encouraging verbal feedback such as ‘More Weight’ to let the patient know he/she needs to push more to reach the target. When the patient reaches the lower limit, the software generates a positive feedback such as ‘Good’—as mentioned before there might be a need for the patient to stay at the target so the software monitor if the patient stays at the target a sufficient amount of time. If successful, the software can generate an additional positive verbal feedback. When the patient does not reach the target and returns to the starting position, and when he/she does not successfully complete the repetition, the software may generate a verbal feedback to encourage the patient to try again (e.g., ‘Try Again’). Examples of verbal feedback are provided in FIG. 70.

Visual Feedback

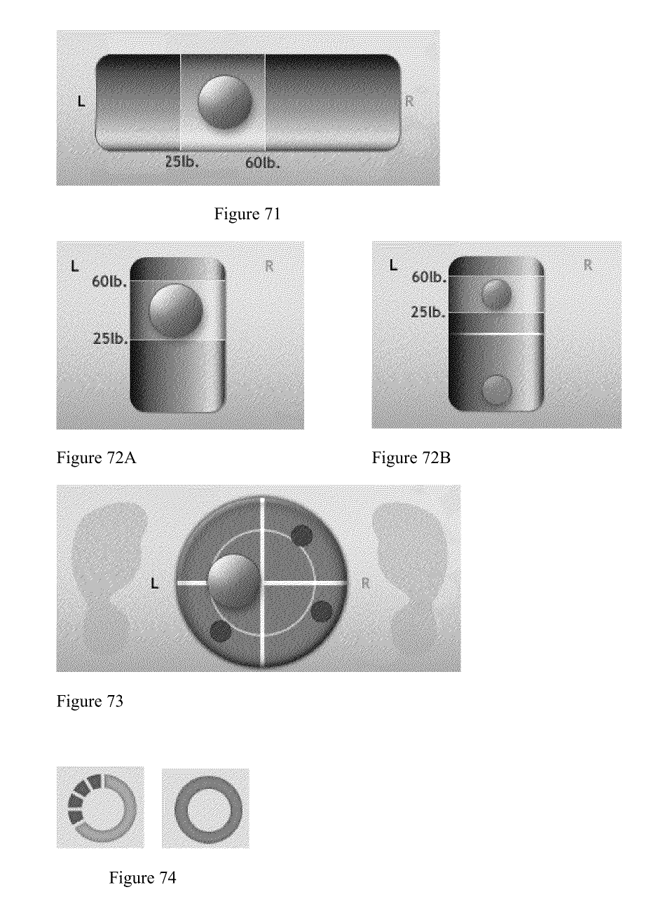

Visual feedback on the handheld device may be used to guide the patient to encourage his/her weight bearing, foot placement, and weight distribution between the hind-foot and fore foot, and between both feet. The visual feedback is targeted for static exercises in front of the handheld display, at the clinic, and at home while it can be added to the audio and/or verbal feedbacks. FIGS. 71-73 illustrate several examples of visual feedbacks for a full span of 100% weight bearing including a horizontal tube scale (FIG. 71), vertical tube scales (FIGS. 72A and 72B), and a target scale (FIG. 73). FIG. 71 illustrates static training exercises for an entire foot (i.e., standing and weight shift). The ball moves from right to left or in the opposite direction on the display according to the affected side. FIGS. 72A and 72B illustrate static training exercises for weight shift AP on the hind foot or forefoot. FIG. 73 illustrates bilateral training.

Time in the Target Feedback

FIG. 74 illustrates an exemplary time in target (TIT) display designed to encourage the patient to stay in a designated weight bearing zone for x seconds until the circle changes color (e.g., becomes green). During the exercise, the patient is instructed to keep the weight for a few seconds in the zone to increase the workout efficacy. A circular feedback counts the time in the target. These parameters (in addition to time, repetition, etc.) are modified during the training program and are set as default values at different exercises for different weeks (e.g., in weight shift AP—first week 1 second; TIT and last week 3 seconds) and is updated according to patient performance.

Compliance Score

A compliance score may be calculated for the patient as a percentage of success at the required repetitions in each exercise. Counting a success is when the patient reaches and/or stays at the limit range. According to the total number of the required repetitions or exercise time, the application will calculate the number of successes divided by the total goals. In dynamic exercises, a success score is defined as a peak value that reaches the lower thresholds. In static exercises, the goal is to reach the target and return back to an initial position. In such as case, a success is counting when the patient reaches at least the lower thresholds, but for counting the next success the weight should be decreased for at least 50% of the lower thresholds to reset the repetition.

Some static exercises (in the Patient mode) can also include the ‘Time in Target’ (TIT) timer where the patient needs to stay inside of the limits for a specific period of time. In this type of exercise, a score will also refer to the success of staying in the target range. While reaching the target is significant more than staying on target, the compliance formula may be as follows:

Score=0.75×(total success reaching)/total required repetitions)+0.25×(total measure time in target)/(total required time)

Thus, if 10 repetitions are set and for each repetition the patient needs to stay at least 10 seconds, the application will count the total time that the patient stayed on the targets.

Total Required repetitions=10

Total required time is 10 rep×10 sec=100 sec

Scenario—patient reaches target only 5 times the target and total time when reaching target was 25 seconds (5 sec per each)

Compliance Score=((5/10)×0.75+(25/100)×0.25)×100=43.75%

Sample List of Static and Dynamic Handheld Training Applications

The table below illustrates exemplary applications that may be loaded into the handheld device to training assessments in accordance with an exemplary embodiment of the invention:

Index

| | | | Assess- |
|---|---|---|---|
| Exercise | | Static/ | ment/ |
| Name | Description | Dynamic | Training |
| Standing | Stand still in normal position. | Static | A/T |
| Sit-to-Stand | Standing up and sitting down | Static | A/T |
| (STS) | (a few repetitions). | | |
| Walking | Walk Across (a few steps.) | Dynamic | A/T |
| Stairs | Ascend and descend Stairs. | Dynamic | A/T |
| Weight Shift | Shift body mass sideway | Static | T |
| Medio-Lateral | Train loading on the entire | | |
| (ML) | foot. | | |
| Weight Shift | Shift body mass forward/ | Static | T |
| Anterior | backward. Train loading on the | | |
| Posterior (AP) | Hind-foot or forefoot. | | |
| Advanced | Shift weight and balance in | Static | T |
| Weight Shift | multiple directions. | | |
| Single Limb | Standing on a single leg | Static | A/T |
| Support (SLS) | | | |
| Squat | Bending bilaterally of the knee | Static | A/T |

*Weight Shift exercises are ‘Training’ exercises only.

### Remote Control First Option-Secured Server (Pc Software)

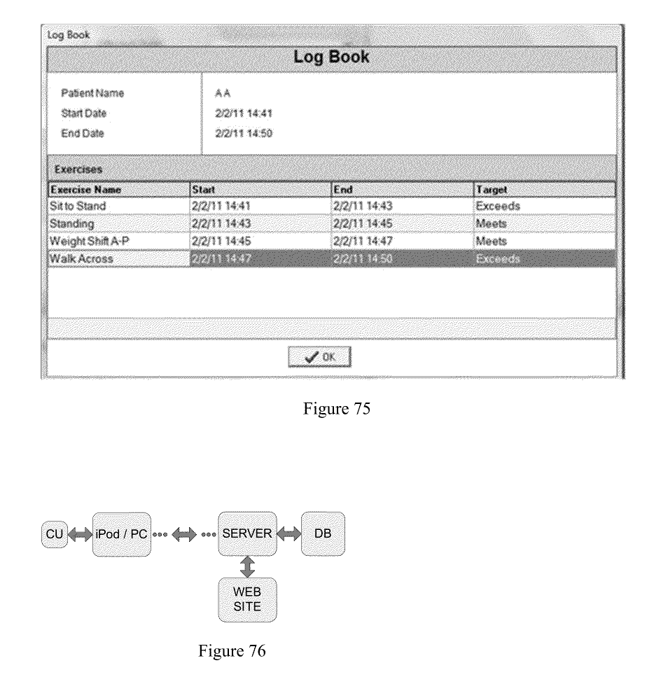

FIG. 75 illustrates a sample log book showing the patient's progress as captured remotely through remote monitoring of the patient while the patient is implementing the training regimen at home and providing periodic updates to the server. Such log may be provided to the therapist to remotely monitor the patient's adherence to therapy, compliance with the therapy program, and to guide automatic updating of the therapy regimen based on the patient's performance.

### Remote Control Second Option-Active Web Server

Use of the web software is accessible for both clinicians and patients, and each has its own authorization. Clinicians can have access for entire patient data from the same clinic and the option to update the patient training program and settings plus the ability to see the progress of their patients. Patients, on the other hand, are not authorized for any editing and have only the option to see their own progress. The system is based on Website software which has the ability to manage users/patient's history results data and to setup and edit clinical data.

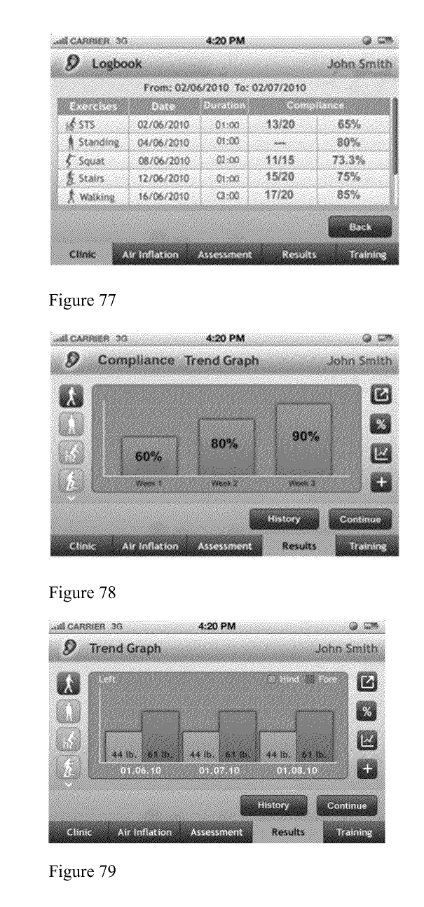

FIG. 76 illustrates the main components of the system. As illustrated, data from local software in the control unit and the handheld (iPod) is synchronized with the server and saved on a database (DB) that gathers all data from the entire clinics and patients. The Web software holds the main user interface and entire operation including data base management software so that there is no need for data base management on the local software. Instead, all operations may be performed through requests to the server. The web software synchronizes data from the local software at the clinic or the patient's personal handheld device. Connections between the local PC software/application and the server website allows clinicians to control and monitor their patients through the web (adjustments of therapy settings and/or the training program, View Historical data on each of the patient's therapy sessions, patients' gait patterns while they are at home, maintenance of hospital OP training sessions, progress trend in Standing/Walking/Stairs etc.) while the patients train at their homes. The server system may also permit orthopedic surgeons and the like to open and see how his/her patient is protecting the surgery in his home program. Notifications of patient progress over time and sessions can be sent to the therapists and physicians, and graphical progress and comparisons may be made available through the web software. The web software UI can display graphs of outcome measures for the clinician or the patient such as compliance in performance and success scores in each exercise as well as a trend summary of the patient's log book trend over days/weeks/months using, e.g., bar charts. FIG. 77 illustrates a sample patient logbook of exercises name, duration, and compliance scores, while FIGS. 78 and 79 illustrate a simple presentation of a trend graph showing the progress by week (FIG. 78) and weight loading (FIG. 79).

Notifications from the patient handheld device to the clinician/orthopedic surgeon can be done through the server using emails, text massages, and the like, including the same communications modalities used by the clinician/orthopedic surgeon to communicate with the patients. Such remote control features and constant bi-directional communication allows better clinical control of the patient's training progress and reduces the need for costly visits at the patient home and/or periodic patient re-evaluations at the clinic. From the administrative view, the use of the remote communication can also give users other options such as setting next appointments at the clinic. Therapists can send notifications to the patients and, upon receipt at the patient's handheld device, the patient can decide if to accept or decline. The invention thus enables the therapist to use web server communications to remotely monitor a patient's progress at home and, if required, to adjust the training program.

Those skilled in the art will appreciate that the system described herein detects gait deviation and patient functional ability in task-specific (sit to stand, standing, step up, etc.) therapies and based on clinical rules builds a training program having a clinical and home based protocol that includes a number of specific functional exercises with the specific thresholds, feedback location, time/repetition, time in the target that is updated through the server on a time basis follow up (thresholds, time/repetition, time in the target, etc.) based on patient performance and or/progress. As noted, the feedback can be accomplished by visual feedback—PC or handheld device, audio—control unit or handheld device, verbal—handheld, and/or vibration—control unit or handheld device. The feedback may be used to enhance loading or timing of loading (gait phases) or foot placement—heel to toe, or distribution between forces on the heel versus toe, or distribution between both legs (bilateral detection and training each time on the other side to get an equal distribution).

Those skilled in the art will also appreciate that the invention may be applied to other applications and may be modified without departing from the scope of the invention. Accordingly, the scope of the invention is not intended to be limited to the exemplary embodiments described above, but only by the appended claims.

What is claimed:

1. A system for providing ambulatory and/or functional performance training to a patient, comprising:
pressure sensors that measure force pressure from at least one of the patient's feet during standing or an exercise from which weight forces at different positions on said at least one patient's foot may be determined; and
a processor programmed to guide ambulatory training and/or functional performance training of the patient in response to outputs of said pressure sensors, said processor training the patient by processing instructions to implement the steps of:
performing a gait analysis or functional performance evaluation of the patient;
providing an objective therapy regimen to the patient based on said gait analysis or functional performance evaluation and predetermined clinical rules;
providing performance feedback and/or post performance feedback to train the patient during standing or an exercise as to proper ambulatory process and/or functional performance process in accordance with a selected exercise of the therapy regimen; and
monitoring the patient's compliance with the provided objective therapy regimen and/or progress in ambulatory status and/or functional performance.

2. A system as in claim 1, wherein said performance feedback is provided based on calculated feedback thresholds that refer to patient body weight and feedback location.

3. A system as in claim 1, wherein said performance feedback is in a feedback modality comprising visual, audio, verbal, vibration, or a combination thereof.

4. A system as in claim 1, further comprising a server that communicates data to/from said processor for remote compliance monitoring and/or progress monitoring of the patient.

5. A system as in claim 1, wherein the processor is programmed to accept threshold adjustments for training parameters of the therapy regimen from said server.

6. A system as in claim 1, wherein said processor is implemented in a handheld computing device and provides said performance feedback using feedback modalities of the handheld computing device.

7. A system as in claim 6, wherein said handheld computing device presents displays that guide the user through the therapy regimen.

8. A system as in claim 1, wherein the processor further processes instructions to enable a user to vary force thresholds in the therapy regimen.

9. A system as in claim 1, wherein the functional performance evaluation includes evaluation of patient response to sit to stand, standing, stepping up and down, and/or stair ascending and/or descending exercises.

10. A system for providing ambulatory and/or functional performance training to a patient, comprising:
pressure sensors that measure force pressure from at least one of the patient's feet during standing or an exercise from which weight forces at different positions on said at least one patient's foot may be determined;
a control unit that determines said weight forces at different positions on said at least one patient's foot and is adapted to wireless transmit said weight forces as weight force data; and
a portable monitoring unit including a processor programmed to guide ambulatory training and/or functional performance training of the patient in response to said weight force data from said control unit, said processor training the patient by processing instructions to implement the steps of:
comparing the weight force data to parameters of an objective therapy regimen that has been personalized to the patient based on a gait analysis or functional performance evaluation of the patient and predetermined clinical rules;
based on said comparison, providing performance feedback and/or post performance feedback to train the patient during standing or an exercise as to proper ambulatory process and/or functional performance process in accordance with a selected exercise of the therapy regimen; and
monitoring the patient's compliance with the objective therapy regimen and/or progress in ambulatory status and/or functional performance.

11. A system as in claim 10, further comprising a remote server that stores the objective therapy regimen and compliance data for the patient and enables access thereto by a doctor and/or therapist.

12. A system as in claim 11, wherein the server enables the doctor or therapist to modify the objective therapy regimen at to transmit modifications thereto to the portable monitoring unit.

13. A system as in claim 10, wherein said performance feedback is provided based on calculated feedback thresholds that refer to patient body weight and feedback location.

14. A system as in claim 13, wherein said performance feedback is in a feedback modality comprising visual, audio, verbal, vibration, or a combination thereof.

15. A system as in claim 10, wherein said portable monitoring unit presents displays that guide the user through an exercise and provide said performance feedback in a visual form.

16. A system as in claim 10, further comprising a Bluetooth™ adapter that enables the portable monitoring unit to wirelessly communicate with said control unit.

17. A method of providing ambulatory and/or functional performance training to a patient, comprising:
performing a gait analysis or functional performance evaluation of the patient using measured force pressures at different positions on at least one foot of the patient during sit to stand, standing, walking and/or ascending/descending stairs exercises;
providing an objective therapy regimen to the patient based on said gait analysis and/or functional performance evaluation and predetermined clinical rules;
providing performance feedback and/or post performance feedback to train the patient as to proper ambulatory process and/or functional performance process in accordance with the selected patient therapy; and
monitoring the patient's compliance and/or progress with the selected patient therapy and/or progress in ambulatory status and/or functional performance.

18. A method as in claim 17, wherein said performance feedback is provided based on calculated feedback thresholds that refer to patient body weight and feedback location.

19. A method as in claim 17, wherein said performance feedback is in a feedback modality comprising visual, audio, verbal, vibration, or a combination thereof.

20. A method as in claim 17, further comprising providing compliance data to a server for remote compliance monitoring of the patient.

21. A method as in claim 17, wherein said performance feedback is provided using feedback modalities of a handheld computing device.

22. A method as in claim 21, further comprising presenting displays on the handheld computing device to guide the user through an exercise of the therapy regimen and to provide visual performance feedback.
